(19) United States
(12) Patent Application Publication
(10) Pub. No.: US 2026/0254518 A1
(43) Pub. Date: Aug. 27, 2026

(54) METHOD AND DEVICE FOR SUPPORTING BEAMFORMING IN WIRELESS COMMUNICATION SYSTEM

(71) Applicant: Samsung Electronics Co., Ltd., Gyeonggi-do (KR)

(72) Inventors: Kyoungmin PARK, Gyeonggi-do (KR); Youngbum KIM, Gyeonggi-do (KR); Hyunseok RYU, Gyeonggi-do (KR); Sungjin PARK, Gyeonggi-do (KR); Cheolkyu SHIN, Gyeonggi-do (KR)

(21) Appl. No.: 19/163,642

(22) PCT Filed: Dec. 26, 2023
(86) PCT No.: PCT/KR2023/021576

§ 371 Date: Sep. 9, 2025

(30) Foreign Application Priority Data
Apr. 17, 2023 (KR) 10-2023-0050332
Jun. 15, 2023 (KR) 10-2023-0076812

(51) Int. Cl. H04B 7/06; H04B 7/08; H04L 5/00

(52) U.S. Cl. CPC H04B 7/06952; H04B 7/088; H04L 5/0048

(57) ABSTRACT

The disclosure relates to a 5G or 6G communication system for supporting a higher data transmission rate. A user equipment (UE) according to an embodiment of the disclosure may receive reference signals from a base station, perform a first operation of applying a first phase shift value to the received reference signals to allow adjacent reference signals on a radio resource to have a set phase difference, perform a second operation of obtaining a combined reference signal by combining the first phase shift value-applied reference signals, perform a third operation of measuring a first reception quality of the combined reference signal, perform the first, second, and third operations by applying at least one second phase shift value instead of the first phase shift value, the at least one second phase shift value including at least one phase shift value to allow the adjacent reference signals to have a phase difference different from the set phase difference, obtain a second reception quality measured for each of the at least one second phase shift value based on the first, second, and third operations performed by applying the at least one second phase shift value, identify at least one phase shift value among the first phase shift value and the at least one second phase shift value based on the first reception quality measured for the first phase shift value and the second reception quality measured for each of the at least one second phase shift value, and transmit, to the base station, at least one of first information indicating the identified at least one phase shift value or second information regarding reference signals phase-shifted by the identified at least one phase shift value and combined.

### TECHNICAL FIELD

Embodiments of the disclosure relate to a method and device for supporting beamforming in a wireless communication system.

### BACKGROUND ART

5G mobile communication technology defines a wide frequency band to enable fast transmission speed and new services and may be implemented in frequencies below 6 GHz (‘sub 6 GHz’), such as 3.5 GHz, as well as in ultra-high frequency bands (‘above 6 GHz’), such as 28 GHz and 39 GHz called millimeter wave (mmWave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access (RACH for NR) to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

In wireless communication systems, such as 5G or 6G mobile communication systems, multiple antennas and/or beamforming technology may be applied to mitigate pathloss of radio waves and/or increase the propagating distance of radio waves. Wireless communication systems adopting beamforming technology require that the optimal beam be selected based on signal quality.

### DISCLOSURE OF INVENTION

### Solution to Problem

An embodiment of the disclosure may provide a method and device for supporting beamforming in a wireless communication system.

An embodiment of the disclosure may provide a method and device for a receiving end (e.g., a UE) to determine information about the beam to be used by a transmitting end (e.g., a base station) in a wireless communication system.

An embodiment of the disclosure may provide a method and device for reducing radio resources used for beam measurement by a receiving end and reducing time delay in beam measurement in a wireless communication system.

An embodiment of the disclosure may provide a method and device for a receiving end to precisely perform beam search based on a reference signal limitedly transmitted by a transmitting end in a wireless communication system.

An embodiment of the disclosure may provide a method and device for a UE to predict the reception quality of reference signals that may have different phase shift values using reference signals transmitted per beam by a base station in a wireless communication system.

An embodiment of the disclosure may provide a method and device for information sharing between a base station and a UE and resource control, required to support beamforming in a wireless communication system.

Objects of the disclosure are not limited to the foregoing, and other unmentioned objects would be apparent to one of ordinary skill in the art from the following description.

According to an embodiment of the disclosure, a method for supporting beamforming by a user equipment (UE) in a wireless communication system may comprise receiving reference signals from a base station, performing a first operation of applying a first phase shift value to the received reference signals to allow adjacent reference signals on a radio resource to have a set phase difference, performing a second operation of obtaining a combined reference signal by combining the first phase shift value-applied reference signals, performing a third operation of measuring a first reception quality of the combined reference signal, performing the first, second, and third operations by applying the at least one second phase shift value instead of the first phase shift value, the at least one second phase shift value including at least one phase shift value to allow the adjacent reference signals to have a phase difference different from the set phase difference, obtaining a second reception quality measured for each of the at least one second phase shift value based on the first, second, and third operations performed by applying the at least one second phase shift value, identifying at least one phase shift value among the first phase shift value and the at least one second phase shift value based on the first reception quality measured for the first phase shift value and the second reception quality measured for each of the at least one second phase shift value, and transmitting, to the base station, at least one of first information indicating the identified at least one phase shift value or second information regarding reference signals phase-shifted by the identified at least one phase shift value and combined.

When the UE has multiple reception antennas, the above operations may be performed independently by each reception antenna or may be performed on reference signals received through some reception antennas. The UE may generate a combination of receiving ends for reference signals received through other reception antennas and the same radio resource and then perform the above operations on reference signals corresponding to the receiving end combination.

According to an embodiment of the disclosure, a method for supporting beamforming by a base station in a wireless communication system may comprise transmitting reference signals, receiving, from a user equipment (UE), at least one of first information indicating at least one phase shift value among a plurality of phase shift values or second information regarding reference signals phase-shifted by the at least one phase shift value and combined, in response to transmitting the reference signals, and performing beamforming for the UE based on the received at least one information. The first information may be used to identify the at least one phase shift value to be applied between antenna elements of the base station, and the second information may be used to determine the antenna elements for beamforming.

According to an embodiment of the disclosure, a user equipment (UE) in a wireless communication system may comprise a transceiver and at least one processor operably connected to the transceiver. The at least one processor may receive reference signals from a base station through the transceiver, perform a first operation of applying a first phase shift value to the received reference signals to allow adjacent reference signals on a radio resource to have a set phase difference, perform a second operation of obtaining a combined reference signal by combining the first phase shift value-applied reference signals, perform a third operation of measuring a first reception quality of the combined reference signal, perform the first, second, and third operations by applying at least one second phase shift value instead of the first phase shift value, the at least one second phase shift value being a value to allow the adjacent reference signals to have a phase difference different from the set phase difference, obtain a second reception quality measured for each of the at least one second phase shift value based on the first, second, and third operations performed by applying the at least one second phase shift value, identify at least one phase shift value among the first phase shift value and the at least one second phase shift value based on the first reception quality measured for the first phase shift value and the second reception quality measured for each of the at least one second phase shift value, and control the transceiver to transmit, to the base station, at least one of first information indicating the identified at least one phase shift value or second information regarding reference signals phase-shifted by the identified at least one phase shift value and combined.

According to an embodiment of the disclosure, a base station in a wireless communication system may comprise a transceiver and at least one processor operably connected to the transceiver. The at least one processor may control the transceiver to transmit reference signals, receive, from a user equipment (UE) through the transceiver, at least one of first information indicating at least one phase shift value among a plurality of phase shift values or second information regarding reference signals phase-shifted by the at least one phase shift value and combined, in response to transmitting the reference signals, and perform beamforming for the UE based on the received at least one information. The first information may be used to identify the at least one phase shift value to be applied between antenna elements of the base station, and the second information may be used to determine the antenna elements for beamforming.

According to an embodiment of the disclosure, it is possible to reduce time delay in beam measurement as well as radio resources used for beam measurement by allowing a receiving end to determine information about the beam for supporting beamforming in a wireless communication system.

According to an embodiment of the disclosure, it is possible for the transmitting end to reduce the number of reference signals to be transmitted and the number of repeated transmissions of reference signals and for the receiving end to more precisely perform beam search using fewer reference signals than those used by the conventional art in a wireless communication system.

According to an embodiment of the disclosure, it is possible for the receiving end to perform precise beam search only with reference signals transmitted by the transmitting end without phase shift.

According to an embodiment of the disclosure, it is possible to perform precise beamforming while reducing overhead due to actual transmission of reference signals by predicting signal quality of reference signal reflecting a predicted phase shift, other than reference signals reflecting a phase shift according to actual transmission in a wireless communication system.

Effects of the disclosure are not limited to the foregoing, and other unmentioned effects would be apparent to one of ordinary skill in the art from the following description.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a view illustrating an example transmission unit of a base station in a wireless communication system according to an embodiment;

FIG. 2 is a view illustrating an example analog beam formed by a base station in a wireless communication system according to an embodiment;

FIG. 3 is a view illustrating an example multi-stage beam management procedure in a wireless communication system according to an embodiment;

FIG. 4 is a signal flowchart illustrating a beam control procedure in a wireless communication system according to an embodiment;

FIG. 5 is a view illustrating operations of a base station and a UE when a reference signal is transmitted through beamforming in a wireless communication system according to an embodiment;

FIG. 6A is a view illustrating operations of a base station and a UE when a reference signal is transmitted through a single antenna without beamforming in a wireless communication system according to an embodiment;

FIG. 6B is a view illustrating operations of a base station and a UE when a reference signal is transmitted through multiple antennas without beamforming in a wireless communication system according to an embodiment;

FIG. 6C is a view illustrating other operations of a base station and a UE when a reference signal is transmitted through multiple antennas without beamforming in a wireless communication system according to an embodiment;

FIG. 7 is a view illustrating a phase difference between reference signals in a wireless communication system according to an embodiment;

FIG. 8A is a view illustrating an example UE structure for combining reference signals per phase shift value in a wireless communication system according to an embodiment;

FIG. 8B is a view illustrating another example UE structure for combining reference signals per phase shift value in a wireless communication system according to an embodiment;

FIG. 8C is a view illustrating an example UE structure for identifying an optimal phase shift value in a wireless communication system according to an embodiment;

FIG. 9 is a view illustrating example SSBs used to obtain a plurality of phase shift values in a wireless communication system according to an embodiment;

FIG. 10 is a flowchart illustrating an example of performing a beam control procedure by a UE in a wireless communication system according to an embodiment;

FIG. 11 is a flowchart illustrating an example of performing a beam control procedure by a base station in a wireless communication system according to an embodiment;

FIG. 12 is a block diagram illustrating a configuration of a UE in a wireless communication system according to an embodiment; and

FIG. 13 is a block diagram illustrating a configuration of a base station in a wireless communication system according to an embodiment.

### MODE FOR THE INVENTION

Hereinafter, the operational principle of embodiments of the disclosure is described below with reference to the accompanying drawings. When determined to make the subject matter of the disclosure unclear, the detailed description of known functions or configurations may be skipped in describing embodiments of the disclosure. The terms described below are defined considering the functions in embodiments of the disclosure and may be replaced with other terms according to the intention or practice of the user or operator. Therefore, the terms should be defined based on the overall disclosure.

When determined to make the subject matter of the disclosure unclear, the detailed description of known functions or configurations may be skipped in describing embodiments of the disclosure.

Hereinafter, the disclosure is described in detail with reference to the accompanying drawings.

As used herein, terms for identifying access nodes, terms denoting network entities, terms denoting messages, terms denoting inter-network entity interfaces, and terms denoting various pieces of identification information are provided as an example for ease of description. Thus, embodiments of the disclosure are not limited by the terms, and such terms may be replaced with other terms denoting objects with equivalent technical concept.

The wireless communication system may include a 5G mobile communication network. The 5G mobile communication network may include a terminal (e.g., a user equipment (UE) or a wireless terminal), a base station (e.g., a radio access network (RAN), a 5g nodeB (gNB), an evolved nodeB (eNB)), and a 5G core network. The 5G core network may include network functions, such as the access and mobility management function (AMF) that provides a mobility management function of the UE, the session management function (SMF) that provides a session management function, the user plane function (UPF) that performs a data transfer role, a policy control function (PCF) that provides a policy control function, a unified data management (UDM) that provides data management functions, such as for subscriber data and policy control data, and unified data repository (UDR) that stores such various network functions.

In the wireless communication system, wireless communication through beamforming may be supported in a millimeter wave (mmWave) or frequency range 2 (FR2). According to an embodiment, a beam management procedure for supporting beamforming is provided in the wireless communication system. The beam management procedure may be a process of updating or managing beamforming in the base station and the UE such that an optimal transmission/reception link (e.g., downlink (DL) or uplink (UL)) is formed or maintained between the base station and the UE. The beam management procedure is required because the location of the UE may be changed or the channel state may be changed. The beam management procedure may include a procedure for beam determination, beam measurement, beam reporting, or beam sweeping.

The beams in the wireless communication system may include the beam formed by the base station (hereinafter, referred to as a “downward beam”) or the beam formed by the UE (hereinafter, referred to as an “upward beam”). The downward beam may include a downward transmission beam formed by the base station to transmit a DL signal or a downward reception beam formed by the base station to receive a UL signal. The downward transmission beam may be the same as or different from the downward reception beam. The upward beam may include an upward reception beam formed by the UE to receive a DL signal or an upward transmission beam formed by the UE to transmit a UL signal. The upward transmission beam may be the same as or different from the upward reception beam.

According to an embodiment, the base station may transmit a DL signal to the UE or may receive a UL signal from the UE through one downward beam. In other words, the downward transmission beam and the downward reception beam formed by the base station to transmit/receive a signal to/from the UE may be the same. For example, the base station may transmit a DL signal to the UE or may receive a UL signal from the UE through a first downward beam. The first downward beam may have beam directivity having a channel environment having a similar DL quality or UL quality. In this case, the UL quality may be predicted by the DL quality.

According to an embodiment, the base station may independently operate a downward transmission beam for transmitting a DL signal to the UE and a downward reception beam for receiving a UL signal from the UE. In other words, the downward transmission beam and the downward reception beam formed by the base station to transmit/receive a signal to/from the UE may be different. For example, the base station may transmit a DL signal to the UE through the first downward beam (e.g., a downward transmission beam) and may receive a UL signal from the UE through a second downward beam (e.g., a downward reception beam). The first downward beam may have beam directivity different from that of the second downward beam. When the beam directivity is different, the channel environment may be different. When the channel environment is different, communication performance (e.g., DL reception quality or UL reception quality) may be different.

According to an embodiment, the UE may receive a DL signal from the base station or may transmit a UL signal to the base station through one upward beam. In other words, the upward transmission beam and the upward reception beam formed by the UE to transmit/receive a signal to/from the base station may be the same. For example, the UE may receive a DL signal from the base station or may transmit a UL signal to the base station through the first upward beam. The first upward beam may have beam directivity having a channel environment having a similar DL quality or UL quality. In this case, the UL quality may be predicted by the DL quality.

According to an embodiment, the UE may independently operate an upward reception beam for receiving a DL signal from the base station and an upward transmission beam for transmitting a UL signal to the base station. In other words, the upward transmission beam and the upward reception beam formed by the UE to transmit/receive a signal to/from the base station may be different. For example, the UE may receive a DL signal from the base station through a first upward beam (e.g., an upward reception beam) and may transmit a UL signal to the base station through a second upward beam (e.g., an upward transmission beam). The first upward beam may have beam directivity different from that of the second upward beam. When the beam directivity is different, the channel environment may be different. When the channel environment is different, communication performance (e.g., DL reception quality or UL reception quality) may be different.

In transmitting a DL signal from the base station to the UE, the wireless communication system may set a pair between an optimal downward transmission beam for the base station to transmit the DL signal and an optimal upward reception beam for the UE to receive the DL signal. In transmitting an UL signal from the UE to the base station, the wireless communication system may set a pair between an optimal upward transmission beam for the UE to transmit the UL signal and an optimal downward reception beam for the base station to receive the UL signal. The beam pair to transmit or receive the DL signal may be the same as or different from the beam pair to transmit or receive the UL signal.

Hereinafter, a beam management procedure performed by a transmitting end and a receiving end in a wireless communication system is described. According to an embodiment, the transmitting end may be a device that transmits a reference signal for beam management, and the receiving end may be a device that receives the reference signal and performs beam measurement. Hereinafter, embodiments in which the transmitting end is a base station and the receiving end is a UE are described. However, embodiments of the disclosure may be applied even when the transmitting end is a UE and the receiving end is a base station.

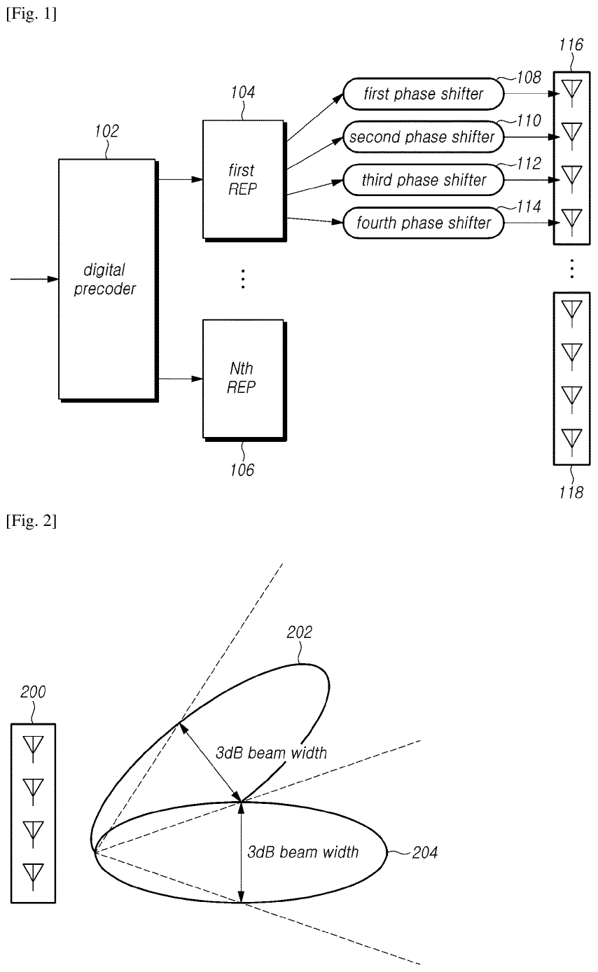

FIG. 1 is a view illustrating an example transmission unit of a base station in a wireless communication system according to an embodiment.

Referring to FIG. 1, a transmission unit (or a transmitter) of a base station may have a hybrid beamforming structure. The hybrid beamforming structure may represent a structure in which digital beamforming (or digital precoding) is performed based on channel state information (CSI) in a baseband, and then analog beamforming is performed by controlling the phase of signals transmitted to antenna elements.

According to an embodiment, the transmission unit of the base station may include a digital precoder 102, a plurality of repeaters (REPs) 104 and 106, a plurality of phase shifters (or beamformers) 108, 110, 112, and 114, and a plurality of sub-arrays 116 and 118.

The digital precoder 102 may precode a signal (e.g., a reference signal) to be transmitted, and may output the precoded signal to at least one (e.g., a first REP 104) of the plurality of repeaters 104 and 106.

At least one of the plurality of REPs 104 and 106 may repeatedly output the precoded signal by a predetermined number of repetitions. The number M of repetitions preset for one REP (e.g., the first REP 104) may be less than or equal to the number of antenna elements included in the associated sub-array (e.g., the first subarray 116) (e.g., when the number of antenna elements included in the sub-array is 4 as shown in FIG. 1, M≤4).

The M signals repeatedly output from at least one (e.g., the first REP 104) of the plurality of REPs 104 and 106 may be input to the plurality of phase shifters 108, 110, 112, and 114, respectively. For example, each of the four signals output from the first REP 104 may be input to a corresponding phase shifter among the first phase shifter 108, the second phase shifter 110, the third phase shifter 112, or the fourth phase shifter 114. The first phase shifter 108, the second phase shifter 110, the third phase shifter 112, or the fourth phase shifter 114 may perform a phase shift on the input signal. The phase shift may be performed without support of the digital beamforming function. For example, the phase shift may be a carrier phase shift that changes the phase of the carrier for analog beamforming. When the carrier phase shift is performed by each of the first phase shifter 108, the second phase shifter 110, the third phase shifter 112, or the fourth phase shifter 114, signals having different phases may be output.

According to an embodiment, the first phase shifter 108, the second phase shifter 110, the third phase shifter 112, or the fourth phase shifter 114, respectively, may be connected to antenna elements included in the first sub-array 116. The first phase shift signal output from the first phase shifter 108 may be transmitted to, e.g., a first antenna element included in the first sub-array 116. The second phase shift signal output from the second phase shifter 110 may be transmitted to, e.g., a second antenna element included in the first sub-array 116. The third phase shift signal output from the third phase shifter 112 may be transmitted to, e.g., a third antenna element included in the first sub-array 116. The fourth phase shift signal output from the fourth phase shifter 114 may be transmitted to, e.g., a fourth antenna element included in the first sub-array 116. Accordingly, signals output from the first phase shifter 108, the second phase shifter 110, the third phase shifter 112, and the fourth phase shifter 114 may form analog beams through the respective corresponding antenna elements and be transmitted.

In general, one of candidate beams transmitted from the base station, i.e., analog beams, may be selected by a node, e.g., the UE, that communicates with the base station. The UE may use the selected analog beam for communication with the base station. For example, for a UE performing communication in the FR2 region, the base station may include an antenna array including a combination of sub-arrays as shown in FIG. 1. Analog beamforming through carrier phase shift may be performed between antenna elements included in each sub-array.

Digital beamforming or digital precoding may be implemented in such a manner as to perform signaling processing for spatial processing between sub-arrays. Based on the above structure, a smaller number of antenna ports may be supported compared to the number of antenna elements included in the antenna array. When the beam of the sub-array is determined to select one of a predetermined limited number of analog beams, the beamforming resolution supportable through the entire antenna array may be reduced. When the beamforming resolution is reduced, the maximum supportable beamforming gain may be reduced.

In order to select an appropriate analog beam in a wireless communication system, the base station may configure a reference signal for beam measurement by the UE for each preconfigured analog beam, and may transmit the reference signal based on the configuration. In other words, the base station may configure more or fewer reference signals than the preset number of analog beams and transmit the configured reference signals. When the base station transmits reference signals corresponding to one beam, the base station may not transmit reference signals corresponding to another beam. As the base station does not simultaneously transmit the reference signals, the UE may receive reference signals corresponding to different beams at different time points, and may measure one analog beam for each received reference signal.

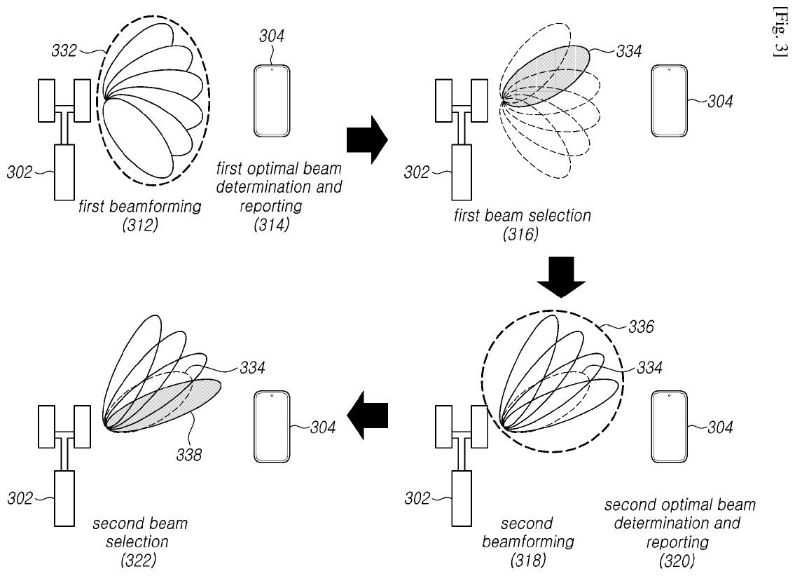

FIG. 2 is a view illustrating an example analog beam formed by a base station in a wireless communication system according to an embodiment.

Referring to FIG. 2, the base station may configure analog beams for each of the analog beams 202 and 204. The analog beam configuration may be related to the beam width. For example, the base station may set the beam width of 3 dB to the beam configuration precision (resolution) to generate a beam having a deterioration of 3 dB or less compared to the maximum beamforming gain that may be supported through each antenna element in the sub-array 200. As the antenna array becomes larger, the 3 dB beam width may become narrower, and as the 3 dB beam width becomes narrower, the number of candidate beams may also increase.

A technique of performing beam measurement and selection based on analog beam sweeping of the base station allows the UE to select an optimal beam through an operation of comparing reception power or reception performance or reception quality (e.g., reference signal received power (RSRP) or signal-to-interference plus noise ratio (SINR)) of reference signals corresponding to the respective beams. Therefore, the technique is widely used in wireless communication systems. When the base station transmits a reference signal for each antenna element without analog beamforming, the reception power of the reference signal may be low, and thus the UE may not estimate beam information or channel information. For this reason, it may be common for the base station to transmit a reference signal through analog beamforming. The technique of using a limited number of analog beams may simplify the operation of the UE and increase the beam measurement accuracy of the UE.

As described above, as the use of a limited number of analog beams may be supported or as the precision of the analog beam is increased, the reference signal overhead and/or the beam measurement overhead for beam measurement may be increased. In other words, the technique of transmitting the reference signal through analog beamforming is limited in increasing the supportable beam control accuracy. This is because high accuracy is required to increase beam control accuracy. As a solution to this problem, a multiple stage beam management procedure may be used. The multi-stage beam management procedure may be, e.g., as shown in FIG. 3.

FIG. 3 is a view illustrating an example multi-stage beam management procedure in a wireless communication system according to an embodiment.

Referring to FIG. 3, the multi-stage beam management procedure may include, e.g., a first beam management procedure and a second beam management procedure.

In the first beam management procedure, a first beamforming operation 312, a first optimal beam determination and reporting operation 314, or a first beam selection operation 316 may be performed.

The first beamforming operation 312 may be an operation in which the base station 302 forms first beams 332 having different directivity (e.g., beams having low directivity or beams having a wide beam width). The first beams 332 having different directivity may be mapped to radio resources allocated for transmission of a first reference signal, e.g., a synchronization signal block (SSB). The base station 302 may sequentially select the first beams 332 based on beam sweeping and transmit the reference signal to the UE 304.

The first optimal beam determination and reporting operation 314 may be an operation in which the UE 304 receives a first reference signal transmitted based on beam sweeping to measure the reception quality of the first beams 332 having different directivity, determines one or more optimal beams considering the measured reception quality, and reports information about the determined one or more optimal beams to the base station 302.

The first beam selection operation 316 may be an operation in which the base station 302 selects the first beam 334 to be allocated for the UE 304 from among the first beams 332, based on information about one or more optimal beams reported from the UE 304.

In the second beam management procedure, a second beamforming operation 318, a second optimal beam determination and reporting operation 320, or a second beam selection operation 322 may be performed.

The second beamforming operation 318 may be an operation in which the base station 302 forms second beams 336 (e.g., beams having high directivity or beams having a narrow beam width) having directivity similar to that of the first beam 334 selected in the first beam management procedure. The second beams 336 may have different directivity. The second beams 336 may be mapped to a radio resource allocated for transmission of a second reference signal such as a channel state information-reference signal (CSI-RS).

The second optimal beam determination and reporting operation 320 may be an operation in which the UE 304 receives a second reference signal transmitted from the base station 302 based on beam sweeping to measure the reception quality of the second beams 336 having different directivity, determines one or more optimal beams considering the measured reception quality, and reports information about the determined one or more optimal beams to the base station 302.

The second beam selection operation 322 may be an operation in which the base station 302 selects the second beam 338 to be allocated for the UE 304 from among the second beams 336, based on information about one or more optimal beams reported from the UE 304. The base station 302 may transmit information about the selected second beam 338 to the UE 304 and may communicate with the UE 304 based on the selected second beam 338.

In the above-described multi-stage beam management procedure, e.g., since operations included in the first beam management procedure and the second beam management procedure should be performed, latency may be caused, and in the second beam management procedure, the width of beam sweeping that the base station 302 may provide, i.e., angular coverage, is very narrow, and thus beam failure may frequently occur. In particular, when the UE 304 is moving or there is a change in the surrounding communication environment such as outdoor communication, the frequency of beam failure may increase. When the beam failure occurs, the base station 302 and the UE 304 may have to perform the multi-stage beam management procedure again from the first beam management procedure. Accordingly, the multistage beam management procedure may not provide a large advantage for delay and overhead reduction.

Considering the above problems, a beam control procedure may be performed. According to an example, the beam control procedure may support beam measurement or beam control of higher precision with fewer reference signal transmissions or with transmission of fewer reference signals. According to an example, when the beam control procedure is performed, the number of candidate beams of the base station 302 that the UE 304 may measure or select may be greater than the number of time-axis radio resources used by the base station 302 to transmit a reference signal to the UE 304. For example, when the base station 302 transmits reference signals through three independent radio resources on the time axis, the UE 304 may estimate more than three candidate beams or may predict reception quality.

According to an example, when the beam control procedure is performed, analog beam measurement and selection in the precision that may theoretically be implemented using digital beamforming may be supported. At least the precision of beam measurement may be secured to be similar to the precision when digital beamforming is used. Alternatively, since the UE 304 may measure beam information of the base station 302 without using the sub-array and the analog beam, full digital beamforming may be implemented.

A proposed beam control procedure is described below in detail.

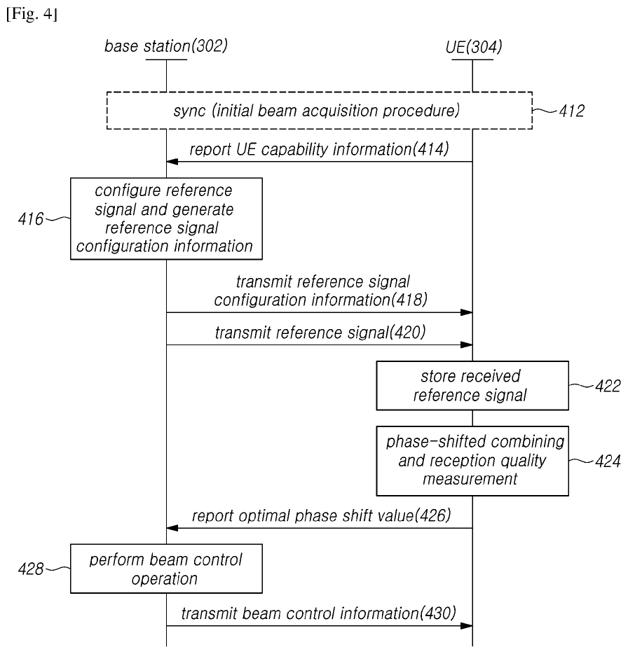

FIG. 4 is a signal flowchart illustrating a beam control procedure in a wireless communication system according to an embodiment.

Referring to FIG. 4, in operation 412, the base station 302 and the UE 304 may perform synchronization. For example, the base station 302 and the UE 304 may share mutual synchronization information and secure synchronization. According to an example, the base station 302 may transmit a reference signal for time and/or frequency synchronization to the UE 304. The base station 302 may transmit a reference signal to the UE 304 through, e.g., broadcasting or UE dedicated signaling. The UE 304 may secure synchronization with the base station 302 based on the reference signal.

In operation 412, the base station 302 and the UE 304 may share information about whether synchronization is achieved, or may exchange information for synchronization adjustment. The information for synchronization adjustment may include, e.g., information for adjusting an upward transmission start time (e.g., an UL slot/symbol start time) of the UE 304. The information for synchronization adjustment may include, e.g., information for adjusting a downward signal transmission time (e.g., a DL slot/symbol start time) of the base station 302. The information for synchronization adjustment may include, e.g., at least one of information for adjusting the upward transmission start time (e.g., an UL slot/symbol start time) or information for adjusting the downward signal transmission time (e.g., a DL slot/symbol start time).

According to an example, in operation 412, an initial beam acquisition procedure between the base station 302 and the UE 304 may be performed. The initial beam acquisition procedure may correspond to, e.g., the first beam management procedure of FIG. 3. When the initial beam acquisition procedure is performed, the base station 302 and the UE 304 may use a beam (e.g., the first beam 334) determined by the first beam management procedure as the initial beam. The initial beam acquisition procedure between the base station 302 and the UE 304 may not be performed. When the initial beam is determined, communication between the base station 302 and the UE 304 in operation 414 and the subsequent operations may be performed based on the initial beam.

In operation 414, the UE 304 may report UE capability information indicating the capability of the UE 304 related to beam search or beam measurement to the base station 302. The UE 304 may report the UE capability information to the base station 302 in response to a request from the base station 302 or without a request from the base station 302. The UE capability information may include, e.g., information about the number of beams of the base station 302 where the UE 304 may perform a search within a set time (e.g., a beam scanning window). The UE capability information may include, e.g., information about beam precision that may be considered when the UE 304 performs a beam search operation. The UE capability information may include, e.g., time delay information required when the UE 304 performs an operation related to beam measurement. The UE capability information may include, e.g., at least one or all of information about the number of beams, information about beam precision, or time delay information. The time delay information that may be included in the UE capability information may be, e.g., information about the time required for the UE 304 to report the beam measurement result after receiving the reference signal for beam search. The time delay information that may be included in the UE capability information may be, e.g., information about the time required for the UE 304 to report the beam measurement result after receiving the beam search instruction.

In operation 416, the base station 302 may configure one or more reference signals for the beam measurement operation of the UE 304 and may generate reference signal configuration information as sub information related to the one or more reference signals.

In operation 418, the base station 302 may transmit the reference signal configuration information to the UE 304. According to an example, the base station 302 may include the reference signal configuration information in measurement or reporting configuration information and transmit the same to the UE 304. According to an example, the reference signal configuration information may include at least one of radio resource information for each reference signal, information about the number of reference signal transmissions, information about the number of radio resources for each reference signal, reference signal sequence information, or reference signal transmission power information.

The radio resource information for each reference signal may include information about one or more reference signal resources used to transmit the reference signal at each transmission occasion. For example, the radio resource information for each reference signal may include information indicating the position of the radio resource on the time and/or frequency axis for each reference signal. According to an example, the radio resource information for each reference signal may include information indicating which resource block (RB) the radio resource used to transmit each reference signal is included in, or information indicating which resource element (RE) of which RB the radio resource used to transmit each reference signal is included in.

According to an example, the radio resource information for each reference signal may include information indicating the number of the symbol to which each reference signal is allocated in the slot where transmission is performed and/or information indicating the number of the subcarrier to which each reference signal is allocated in the slot of a specific RB.

According to an example, the radio resource information for each reference signal may include at least one of information about one or more cells transmitting each reference signal, information about the serving cell referring to the timing for reference signal (e.g., CSI-RS) resources without an associated SSB, subcarrier spacing information about the reference signal, associated SSB information, reference signal index information associated with the reference signal radio resource, information indicating the first orthogonal frequency division multiplexing (OFDM) symbol in the RB where the reference signal is used, frequency domain allocation information in the RB, information indicating that the reference signal radio resource is quasi co-located with the SSB or physical broadcast channel (PBCH) block, scrambling identifier (ID) information about the reference signal, or reference signal periodicity and offset (e.g., number of slots) information.

The information about the number of reference signal transmissions or the information about the number of reference signal radio resources may include information about how many independent reference signals the UE 304 needs to receive for a beam search. For example, when the UE 304 needs to receive four reference signals, the information about the number of reference signal transmissions may include information indicating that four reference signal transmissions are performed on different radio resources, and the information about the number of reference signal radio resources may include information indicating that the number of radio resources used for reference signal transmission is four. Based on this, the UE 304 may separately receive four reference signals through four independent radio resources and perform a beam search using the four reference signals.

The reference signal sequence information or the reference signal transmission power information may be information necessary for receiving and measuring each reference signal that may be used by the UE 304.

When the base station 302 generates a plurality of pieces of reference signal configuration information in operation 416, the base station 302 may transmit, to the UE 304, indication information indicating at least one of the plurality of pieces of reference signal configuration information to be used for reference signal transmission in operation 418 or a separate operation. The base station 302 may transmit the indication information to the UE 304 using a medium access control (MAC) control element (CE) or downlink control information (DCI). Upon receiving the reference signal configuration information from the base station 302, the UE 304 may obtain at least one of radio resource information for each reference signal, information about the number of reference signal transmissions, information about the number of reference signal radio resources, reference signal sequence information, or reference signal transmission power information.

In operation 420, the base station 302 may transmit the reference signal, based on the reference signal configuration information.

In operation 422, the UE 304 may receive M reference signals from the base station 302 or reference signals transmitted M times from the base station 302, based on at least one piece of information obtained from the reference signal configuration information, and may store the reference signals in the buffer. According to an example, M may denote a natural number equal to or greater than 2, and the M reference signals or the reference signals transmitted M times may be a plurality of reference signals respectively corresponding to independent radio resources. According to an example, the independent radio resource may be radio resources divided on the time axis and/or frequency axis, radio resources forming a sequence for each reference signal on the time axis and/or the frequency axis, radio resources for each reference signal distinguished based on a code, or all kinds of dividable radio resources. For example, when the plurality of reference signals corresponds to radio resources divided on the time axis, the UE 304 may receive each of the plurality of reference signals through an independent radio resource corresponding to a corresponding reception time (occasion). The UE 304 may separately store a plurality of reference signals received at the respective reception times in the buffer.

In operation 424, as an operation related to beam search, the UE 304 may perform a phase shifted combining operation (or a phased combining operation) and a reception quality measurement operation. According to an example, the phase shifted combining operation may include an operation of performing phase shift based on a phase shift value set for a plurality of received reference signals and combining the plurality of phase-shifted reference signals. For example, when the phase shift value of ‘θ’ is set, the UE 304 receiving the first to third reference signals may perform the phase shift of ‘θ’ on the second reference signal and may perform the phase shift of ‘θ×2’ on the third reference signal. For example, the UE 304 may not perform phase shift on the first reference signal. The UE 304 may perform an operation of combining the first reference signal, the phase-shifted second reference signal, and the phase-shifted third reference signal.

According to an example, the UE 304 may perform a plurality of phase shifted combining operations based on a plurality of phase shift values (e.g., θ₁, θ₂, θ₃ . . . , θₙ). The plurality of phase shift values may be obtained in various ways. For example, the UE 304 may determine the plurality of phase shift values based on beam information (e.g., direction information about the first beam 334) obtained in an initial access operation or the synchronization operation with the base station 302.

For example, the UE 304 may receive information about the plurality of phase shift values from the base station 302 through MAC CE or DCI. For example, the information about the plurality of phase shift values may include information directly indicating the phase shift values or information indicating a reference phase shift value. When information indicating the reference phase shift value (e.g., 40° (or 40 degrees)) is obtained, the UE 304 may determine a set number (e.g., 5) of phase shift values (e.g., 30°, 35°, 40°, 45°, and 50°) having a set phase difference (e.g., 5°) as the plurality of phase shift values based on the reference phase shift value.

For example, the UE 304 may determine the plurality of phase shift values based on information provided by the base station 302. For example, the UE 304 may obtain, from a system information block (SIB) transmitted from the base station 302, information indicating the phase value through which the SSB received to secure synchronization with the base station 302 has been transmitted. According to an example, when it is identified that the UE 304 has secured the synchronization with the base station 302 through the SSB transmitted at the phase value of 45° based on the SIB, the UE 304 may determine the plurality of phase shift values as {35°, 40°, 45°, 50°, 55° }.

For example, the UE 304 may determine the plurality of phase shift values based on transmission configuration indicator (TCI) state information. The TCI state information may be included, e.g., in the reference signal configuration information. The TCI state information is transmission configuration information for each reference signal and may include information about the phase shift value. According to an example, information about the phase shift value may be mapped to each TCI state information.

The UE 304 may perform the phase shifted combining operation based on each of the plurality of phase shift values. In other words, the UE 304 may perform phase shift on the plurality of received reference signals using each phase shift value, and may combine the plurality of phase-shifted reference signals. The UE 304 may perform a measurement operation of measuring reception quality (e.g., RSRP) of the plurality of reference signals combined based on each phase shift value. The UE 304 may identify an optimal phase shift value corresponding to the reception quality (e.g., the reception quality equal to or greater than a threshold value or the best reception quality) that meets a set criterion among the plurality of phase shift values. According to an embodiment, there may be one or more optimal phase shift values.

When the optimum phase shift value is identified, the UE 304 may report the optimum phase shift value to the base station 302 in operation 426. The UE 304 may transmit additional information together with the optimal phase shift value to the base station 302. The UE 304 may transmit additional information to the base station 302 separately from the optimal phase shift value. The additional information may include, e.g., information about a plurality of reference signals combined based on the optimal phase shift value (hereinafter, referred to as ‘optimal combined reference signals’). The additional information may include, e.g., information about the reception quality of the optimal combined reference signals. The additional information may include, e.g., at least one of information about optimal combined reference signals or information about reception quality of optimal combined reference signals. The information about the optimal combined reference signals may include information about the number of optimal combined reference signals. The information about the optimal combined reference signals may include resource index information about each of the optimal combined reference signals. The information about the optimal combined reference signals may include at least one of information about the number of optimal combined reference signals or resource index information about each of the optimal combined reference signals.

According to an example, when the target reception quality meeting a set criterion is −80 dBm or more and the base station 302 transmits eight reference signals, the UE 304 may receive eight reference signals. The UE 304 may perform a phase shifted combining operation and a measurement operation on the received eight reference signals based on a plurality of phase shift values. The UE 304 may determine four reference signals received with a reception quality of −78 dBm among the eight reference signals as optimal combined reference signals. For example, when the four reference signals are phase-shifted at 400 and combined, the UE 304 may determine 400 as an optimal phase shift value.

When four reference signals are combined by applying an optimal phase shift value of 40°, the UE 304 may report to the base station 302 that the target reception quality is achievable. For example, the UE 304 may transmit {phase shift value (e.g., 40°), number of reference signals (e.g., 4)} to the base station 302. For example, the UE 304 may transmit {phase shift value, reference signal resource index (e.g., resource index corresponding to four reference signals)} to the base station 302. For example, the UE 304 may separately transmit {phase shift value} and {number of reference signals}, and/or {reference signal resource index} to the base station 302. For example, the UE 304 may separately transmit {phase shift value (e.g., 40°), number of reference signals (e.g., four)}, {phase shift value, reference signal resource index (e.g., resource index corresponding to four reference signals)}, or {phase shift value}, {number of reference signals}, and/or {reference signal resource index} to the base station 302.

When a plurality of {phase shift value} and {number of reference signals}, and/or {reference signal resource index} capable of achieving the target reception quality are obtained, the UE 304 may report the plurality of pieces of information to the base station 302 on a per-set basis. For example, the UE 304 may transmit a set of a plurality of {phase shift value, number of reference signals} to the base station 302. For example, the UE 304 may transmit a set of a plurality of {phase shift value, reference signal resource index} to the base station 302. For example, the UE 304 may transmit each of a set of a plurality of {phase shift value}, a set of a plurality of {number of reference signals}, and/or a set of a plurality of {reference signal resource index} to the base station 302.

In operation 428, the base station 302 may perform a beam control operation based on the optimal phase shift value and/or additional information received from the UE 304. The beam control operation may include an operation of controlling an antenna array (or sub-array) of the base station 302 to form a beam for communication with the UE 304. When the base station 302 intends to transmit a signal to the UE 304 using the antenna array, the optimal phase shift value reported from the UE 304 may be an estimated value for a phase difference occurring between antenna elements included in the antenna array. Accordingly, the base station 302 may use an optimal phase shift value to perform beamforming for the UE 304. For example, when the optimal phase shift value is 30°, the base station 302 may perform beamforming for the UE 304 by applying a phase shift value of 30° between the antenna elements. The antenna elements to which the phase shift value of 30° is applied may be antenna elements where the optimal combined reference signals, respectively, are transmitted.

When the number of reference signals (i.e., the number of optimal combined reference signals) reported by the UE 304 is smaller than the set number of reference signal transmissions or the size of the antenna array (or sub-array) that the base station 302 may use for beamforming, the base station 302 may apply beamforming using part of the antenna array to communication with the UE 304 by reflecting the reported number. In this case, the base station 302 may transmit information about part of the antenna array used for beamforming or information about the changed size of the antenna array to the UE 304. For example, the base station 302 may change configuration information about the reference signal to be used for channel measurement (e.g., CSI measurement) in response to the changed antenna array, and may transmit the changed configuration information to the UE 304.

In operation 430, the base station 302 may transmit information about the final beam determined by the beam control operation to the UE 304. According to an example, the information about the final beam may include a phase shift value related to the final beam or information (e.g., an indicator or an index) indicating the phase shift value. For example, when the base station 302 transmits information directly indicating the phase shift value to the UE 304 or when the UE 304 reports one or more optimal phase shift values, the base station 302 may transmit information indicating one of one or more optimal phase shift values to the UE 304. For example, when the UE 304 reports {40°, 45°, 50° } as the optimal phase shift values, the base station 302 may transmit to the UE 304 that the use of the beam corresponding to the phase shift value {40° } is determined in a manner indicating an index of {0}.

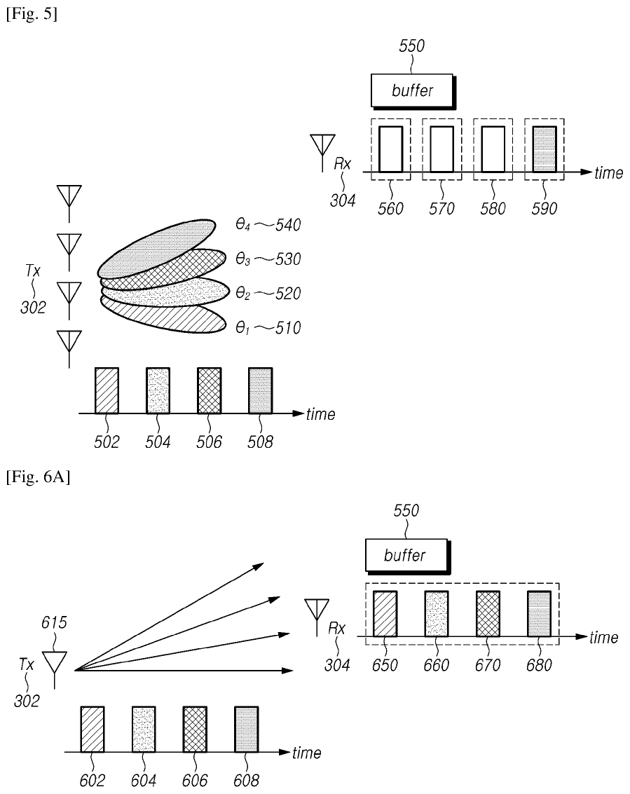

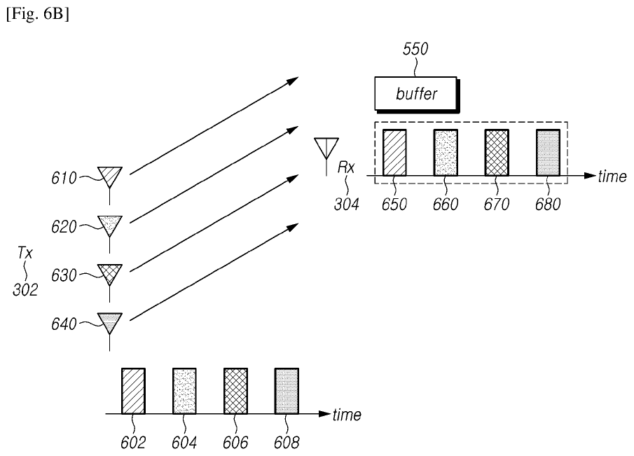

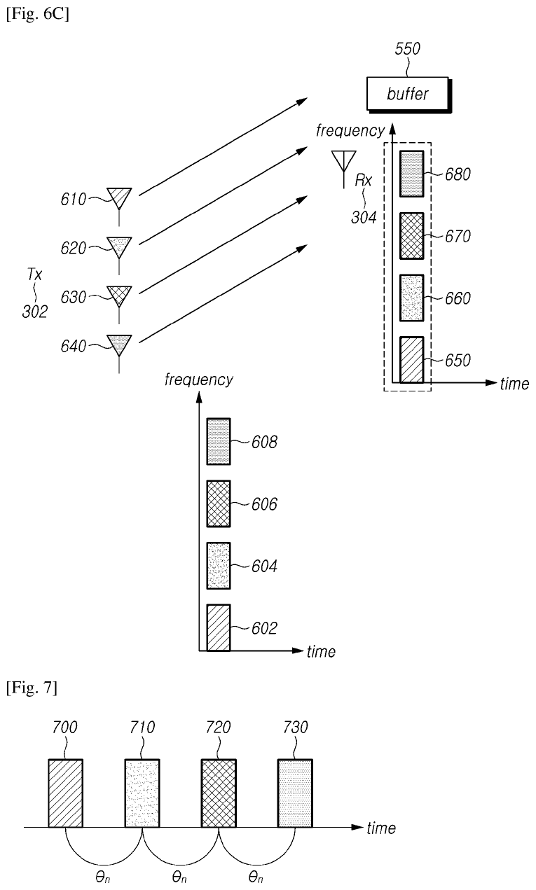

Hereinafter, referring to FIGS. 5 and 6A to 6C, operations of the base station and the UE when a reference signal is transmitted through beamforming and operation of the base station and the UE when a reference signal is transmitted without beamforming are compared and described. Here, for convenience of description, it is assumed that the number of repeated transmissions of the reference signal or the number of transmitted reference signals is 4, but the number of repeated transmissions of the reference signal or the number of transmitted reference signals may be set to a different value (e.g., a natural number of 2 or more such as 2, 3, 5, or M) according to an embodiment.

FIG. 5 is a view illustrating operations of a base station and a UE when a reference signal is transmitted through beamforming in a wireless communication system according to an embodiment.

Referring to FIG. 5, the base station 302 may repeatedly transmit a reference signal through beam sweeping, based on antenna elements (or sub-arrays). The reference signal may be repeated in set units (e.g., units of OFDM symbols) on the radio resource (e.g., time domain). In FIG. 5, repeated transmission of the reference signal may indicate that the base station 302 transmits the reference signal repeated in set units on the radio resource using beams in different directions. The beams in different directions may be beams having different phase values (e.g., θ₁, θ₂, θ₃, and θ₄ 510, 520, 530, and 540) formed by the base station 302.

According to an embodiment, as illustrated in FIG. 5, when the reference signal is repeated four times in the time domain and the reference signals repeated four times are denoted as a first reference signal 502, a second reference signal 504, a third reference signal 506, and a fourth reference signal 508, respectively, the base station 302 may perform the following transmission operations. The base station 302 may transmit the first reference signal 502 using a first time resource through a first beam formed with the phase value 510 of θ₁. The base station 302 may transmit the second reference signal 504 using a second time resource through a second beam formed with the phase value 520 of 02. The base station 302 may transmit the third reference signal 506 using a third time resource through a third beam formed with the phase value 530 of θ₃. The base station 302 may transmit the fourth reference signal 508 using a fourth time resource through a fourth beam formed with the phase value 540 of θ₄.

For example, the phase values (e.g., θ₁, θ₂, θ₃, and θ₄ 510, 520, 530, and 540) respectively corresponding to the beams may be different. The phase values respectively corresponding to the beams may be ones considering the phase shift in the radio section until the first to fourth reference signals 502, 504, 506, and 508 transmitted through the respective beams are received by the UE 304. In other words, the degrees of phase shift which the first to fourth reference signals 502, 504, 506, and 508 transmitted for each beam are to have at the times when they are received by the UE 304 may be different.

When the base station 302 transmits the first to fourth reference signals 502, 504, 506, and 508 using different time resources through beam sweeping, the UE 304 may receive a reference signal (e.g., the fourth reference signal 508) transmitted through a beam (e.g., the fourth beam) having a specific phase value (e.g., θ₄ 540) among the beams of the base station 302 at any time point. The beam having the specific phase value may be, e.g., a beam in the direction corresponding to the location of the UE 304.

According to an example, the UE 304 may not receive the remaining reference signals (e.g., the first to third reference signals 502, 504, and 506) transmitted through the beams having the remaining phase values (e.g., θ₁, θ₂, and θ₃ 510, 520, and 530). The remaining reference signals may be reference signals transmitted through beams in directions not corresponding to the location of the UE 304, i.e., beams (e.g., first to third beams) having phase values (e.g., θ₁, θ₂, and θ₃ 510, 520, and 530) different from a specific phase value (e.g., θ₄ 540).

According to an example, the state of the buffer 550 of the UE 304 may vary based on whether the UE 304 has received each reference signal. For example, when the UE 304 does not receive the first to third reference signals 502, 504, and 506 at the first to third reception times, the first to third reference signals 502, 504, and 506 may not be stored in the storage spaces 560, 570, and 580 of the buffer 550 corresponding to the first to third reception times. When the UE 304 receives the fourth reference signal 508 at the fourth reception time, the fourth reference signal 508 may be stored in the storage space 590 of the buffer 550 corresponding to the fourth reception time. The UE 304 may measure the reception quality of the fourth reference signal 508, and may select the fourth beam corresponding to the fourth reference signal 508 as the optimal beam and report it to the base station 302 when the measured reception quality meets a set criterion (e.g., when the measured reception quality is equal to or greater than a threshold). When the measured reception quality does not meet the set criterion, the UE 304 may discard the fourth reference signal 508 and again perform the beam management procedure as illustrated in FIG. 3.

FIGS. 6A to 6C are views illustrating operations of a base station 302 and a UE 304 when a reference signal is transmitted without beamforming in a wireless communication system according to an embodiment. FIG. 6A is a view illustrating operations of a base station 302 and a UE 304 when the base station 302 transmits a reference signal using a single antenna. FIGS. 6B and 6C are views illustrating operations of a base station 302 and a UE 304 when the base station 302 transmits a reference signal using multiple antennas. Hereinafter, FIGS. 6A to 6C are described one by one.

FIG. 6A is a view illustrating operations of a base station and a UE when a reference signal is transmitted through a single antenna without beamforming in a wireless communication system according to an embodiment.

Referring to FIG. 6A, the base station 302 may repeatedly transmit a reference signal without performing beam sweeping, based on an antenna element (or sub-array) 615 corresponding to a single antenna. In FIG. 6A, repeated transmission of the reference signal may indicate that the base station 302 transmits the reference signal a set number of times (e.g., M times) through the antenna element 615. For example, when the set number of times is 4 (i.e., when M=4), the base station 302 may transmit the reference signal four times through the antenna element 615.

According to an example, when the reference signal is repeated four times in the time domain and the reference signals repeated four times are denoted as a first reference signal 602, a second reference signal 604, a third reference signal 606, and a fourth reference signal 608, respectively, the base station 302 may transmit the first to fourth reference signals 602, 604, 606, and 608 through one antenna element 615 using different time resources.

For example, the base station 302 may transmit the first reference signal 602 through the antenna element 615 using the first time resource. For example, the base station 302 may transmit the second reference signal 604 through the antenna element 615 using the second time resource. For example, the base station 302 may transmit the third reference signal 606 through the antenna element 615 using the third time resource. For example, the base station 302 may transmit the fourth reference signal 608 through the antenna element 615 using the fourth time resource. In other words, the base station 302 may sequentially transmit the first to fourth reference signals 602, 604, 606, and 608 through the antenna element 615, thereby performing four reference signal transmissions.

The UE 304 may receive the first to fourth reference signals 602, 604, 606, and 608 transmitted by the base station 302. In some cases, the UE 304 may receive some of the first to fourth reference signals 602, 604, 606, and 608. For example, the UE 304 may receive some (e.g., the first and second reference signals 602 and 604) of the first to fourth reference signals 602, 604, 606, and 608, based on the location of the UE 304 (e.g., when the UE 304 is located at a cell edge) or an environment (e.g., an environment in which an obstacle obstructing communication exists). Even in this case, the proposed beam control procedure may be applied, but an example in which the UE 304 receives the first to fourth reference signals 602, 604, 606, and 608 transmitted by the base station 302 is described below.

The UE 304 may store the received reference signal in the buffer 550. For example, when the UE 304 receives the first to fourth reference signals 602, 604, 606, and 608 at the first to fourth reception times, the UE 304 may separately store the received first to fourth reference signals 602, 604, 606, and 608 in the buffer 550. For example, the UE 304 may sequentially store the first to fourth reference signals 602, 604, 606, and 608 in the storage spaces 650, 660, 670, and 680 of the buffer 550 corresponding to the first to fourth reception times.

FIG. 6B is a view illustrating operations of a base station and a UE when a reference signal is transmitted through multiple antennas without beamforming in a wireless communication system according to an embodiment. Referring to FIG. 6B, the base station 302 may repeatedly transmit a reference signal without performing beam sweeping, based on antenna elements (or sub-arrays) corresponding to multiple antennas. In FIG. 6B, repeated transmission of the reference signal may indicate that the base station 302 transmits the reference signal a set number of times (e.g., M times) through the antenna elements (e.g., the first to fourth antenna elements 610, 620, 630, and 640). For example, when the set number of times is 4 (i.e., when M=4), the base station 302 may transmit the reference signal four times through the first to fourth antenna elements 610, 620, 630, and 640.

According to an example, when the reference signal is repeated four times in the time domain and the reference signals repeated four times are denoted as a first reference signal 602, a second reference signal 604, a third reference signal 606, and a fourth reference signal 608, respectively, the base station 302 may transmit the first to fourth reference signals 602, 604, 606, and 608 through the first to fourth antenna elements 610, 620, 630, and 640, respectively, using different time resources. For example, the base station 302 may transmit the first reference signal 602 through the first antenna element 610 using the first time resource. For example, the base station 302 may transmit the second reference signal 604 through the second antenna element 620 using the second time resource. For example, the base station 302 may transmit the third reference signal 606 through the third antenna element 630 using the third time resource. For example, the base station 302 may transmit the fourth reference signal 608 through the fourth antenna element 640 using the fourth time resource. In other words, the base station 302 may sequentially transmit the first to fourth reference signals 602, 604, 606, and 608 through the first to fourth antenna elements 610, 620, 630, and 640, thereby performing four reference signal transmissions.

According to an example, the base station 302 may perform reference signal transmission through antenna elements fewer than the number of repeated transmissions of the reference signal. For example, the base station 302 may transmit the first to fourth reference signals 602, 604, 606, and 608 through the first antenna element 610 and the second antenna element 620. For example, the base station 302 may transmit the first reference signal 602 through the first antenna element 610 using the first time resource. For example, the base station 302 may transmit the second reference signal 604 through the first antenna element 610 using the second time resource. For example, the base station 302 may transmit the third reference signal 606 through the second antenna element 620 using the third time resource. For example, the base station 302 may transmit the fourth reference signal 608 through the second antenna element 620 using the fourth time resource.

The UE 304 may receive the first to fourth reference signals 602, 604, 606, and 608 transmitted by the base station 302. The UE 304 may store the received reference signal in the buffer 550. For example, when the UE 304 receives the first to fourth reference signals 602, 604, 606, and 608 at the first to fourth reception times, the UE 304 may separately store the received first to fourth reference signals 602, 604, 606, and 608 in the buffer 550. For example, the UE 304 may sequentially store the first to fourth reference signals 602, 604, 606, and 608 in the storage spaces 650, 660, 670, and 680 of the buffer 550 corresponding to the first to fourth reception times.

FIG. 6C is a view illustrating other operations of a base station and a UE when a reference signal is transmitted through multiple antennas without beamforming in a wireless communication system according to an embodiment.

Referring to FIG. 6C, the base station 302 may transmit a set number (e.g., M) of reference signals repeated ion the frequency domain without performing beam sweeping, based on antenna elements (or sub-arrays) corresponding to multiple antennas.

According to an example, when the reference signal is repeated four times in the frequency domain (i.e., when M=4), the base station 302 may transmit four reference signals (e.g., the first to fourth reference signals 602, 604, 606, and 608) through antenna elements (e.g., the first to fourth antenna elements 610, 620, 630, and 640).

The base station 302 may transmit the first to fourth reference signals 602, 604, 606, and 608, respectively, using the same time resource and different frequency resources. For example, the base station 302 may transmit the first reference signal 602 through the first antenna element 610 using the first time resource and the first frequency resource. For example, the base station 302 may transmit the second reference signal 604 through the second antenna element 620 using the first time resource and the second frequency resource. For example, the base station 302 may transmit the third reference signal 606 through the third antenna element 630 using the first time resource and the third frequency resource. For example, the base station 302 may transmit the fourth reference signal 608 through the fourth antenna element 640 using the first time resource and the fourth frequency resource. In other words, the base station 302 may simultaneously transmit the first to fourth reference signals 602, 604, 606, and 608 through the first to fourth antenna elements 610, 620, 630, and 640.

The UE 304 may store the received reference signal in the buffer 550. For example, when the UE 304 receives the first to fourth reference signals 602, 604, 606, and 608 at the first reception time, the UE 304 may separately store the received first to fourth reference signals 602, 604, 606, and 608 in the buffer 550. For example, the UE 304 may separately store the first to fourth reference signals 602, 604, 606, and 608 in the storage spaces 650, 660, 670, and 680 of the buffer 550 corresponding to the first to fourth frequency resources of the first reception time.

Although not illustrated, the base station 302 may transmit four reference signals 602, 604, 606, and 608 using different time resources and different frequency resources, and the UE 304 may store the four reference signals 602, 604, 606, and 608 received using different time resources and different frequency resources in the buffer 550.

Based on the reference signal transmission/reception operations described with reference to FIGS. 6A to 6C, the UE 304 may perform a beam control procedure. The beam control procedure may include an operation in which the UE 304 performs phase shift on the reference signals. The operation of performing the phase shift may be an operation to allow a specific phase difference to be present between reference signals.

FIG. 7 is a view illustrating a phase difference between reference signals in a wireless communication system according to an embodiment.

Referring to FIG. 7, the UE 304 may perform phase shift on M reference signals (or reference signals transmitted M times). When the UE 304 receives M reference signals and stores the M reference signals in the buffer, the UE 304 may perform phase shift on the stored M reference signals (e.g., the first to fourth reference signals 700, 710, 720, and 730 when M is 4), and may perform a phase shifted combining operation of combining the phase-shifted M reference signals.

The UE 304 may perform the phase shifted combining operation several times based on a plurality of phase shift values (e.g., θ₁, θ₂, θ₃ . . . , θₙ). This may be expressed as Equation 1 below.

Referring to Equation 1, the UE 304 may perform the phase shift operation on the first to fourth reference signals 700, 710, 720, and 730 so that the phase differences between adjacent reference signals on the radio resource (e.g., time domain) are
θ₁, θ₂, θ₃ . . . , θₙ
(1≤n≤N, where N denotes the total number of phase shift values or the maximum number of phase shift operations. In Equation 1, as an example, n is a natural number of 4 or more). According to an example, when the phase shift is performed, four or more phase differences between adjacent reference signals may be considered, but less than four phase differences between adjacent reference signals may be considered.

The UE 304 may perform phase shift on the first to fourth reference signals 700, 710, 720, and 730, based on each of the plurality of phase shift values
θ₁, θ₂, θ₃ . . . , θₙ.

The UE 304 may combine or sum the phase-shifted first to fourth reference signals 700, 710, 720, and 730, for each phase shift value. For example, in Equation 1, “Sum with phase shift
θ₁
   btw adjacent RS” may indicate a combination of the first to fourth reference signals 700, 710, 720, and 730 when the phase difference between adjacent reference signals is
θ₁.
   Sum with phase shift
θ₂
   btw adjacent RS may indicate a combination of the first to fourth reference signals 700, 710, 720, and 730 when the phase difference between adjacent reference signals is
θ₂.
   Sum with phase shift
θ₃
   btw adjacent RS may indicate a combination of the first to fourth reference signals 700, 710, 720, and 730 when the phase difference between adjacent reference signals is
θ₃.
   Sum with phase shift
θₙ
   btw adjacent RS may indicate a combination of the first to fourth reference signals 700, 710, 720, and 730 when the phase difference between adjacent reference signals is
θₙ.

The UE 304 may obtain the reception quality for each phase shift value by measuring the reception quality of the reference signals combined for each phase shift value. The UE 304 may identify a reception quality (e.g., a reception quality equal to or greater than a threshold or the best reception quality) that meets a set criterion among the reception qualities for each phase shift value. The UE 304 may obtain at least one phase shift value corresponding to the identified reception quality among the plurality of phase shift values as an optimal phase shift value.

The UE 304 may transmit information about the optimal phase shift value to the base station 302. As additional information, the UE 304 may transmit, to the base station 302, at least one of information about optimal combination reference signals (e.g., information about the number of optimal combination reference signals and/or resource index information about each of the optimal combination reference signals) or information about the reception quality of the optimal combination reference signals.

The base station 302 may perform a beam control operation based on the optimal phase shift value and additional information received from the UE 304. The beam control operation may include an operation in which the base station 302 determines a phase difference between antenna elements based on an optimal phase shift value to form a beam for communication with the UE 304. According to an example, the antenna elements may be antenna elements that have transmitted optimal combined reference signals.

Compared with the beam management procedure described with reference to FIG. 5, the beam control procedure described with reference to FIG. 7 may perform relatively precise beam search without increasing reference signals and/or beam sweeping. For example, it is possible to achieve precise beamforming of the base station 302 for the UE 304 while reducing the overhead of the base station 302 by enabling more than M beam searches to be performed based on M reference signal transmissions or transmission of M reference signals.

According to an example, when the UE 304 moves to the cell edge of the base station 302, the UE 304 may receive reference signals from another base station in addition to the reference signals from the base station 302. In this case, the UE 304 may perform a beam control procedure on each of the base station 302 and/or the other base station. According to an example, when the reception quality of the reference signal of the other base station is better than the reception quality of the reference signal of the base station 302, the UE 304 may terminate the beam control procedure with the base station 302, report the optimal phase shift value to the other base station, and communicate with the other base station. Alternatively, when the reception quality of the reference signal of the other base station is not better than the reception quality of the reference signal of the base station 302, the UE 304 may terminate the beam control procedure with the other base station and may continue the beam control procedure with the base station 302. In other words, the UE 304 may report the optimal phase shift value to the base station 302 and perform communication with the base station 302.

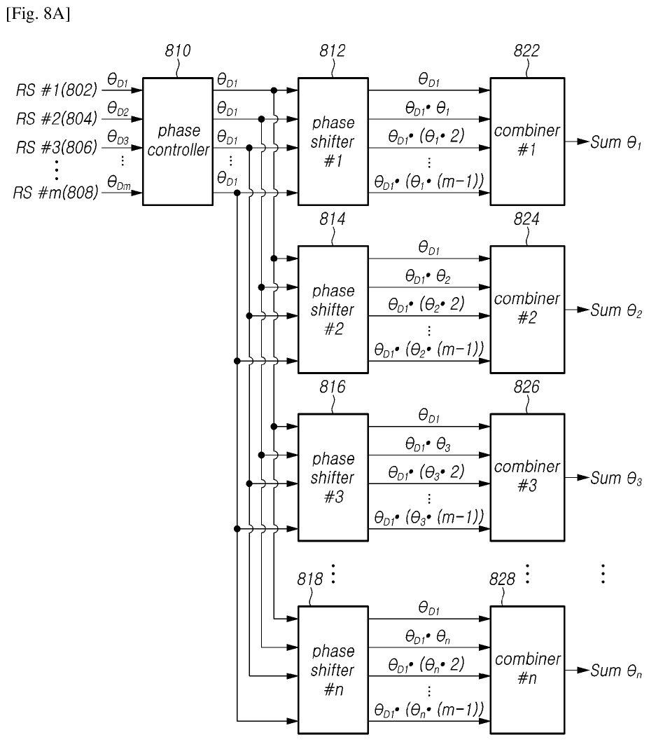

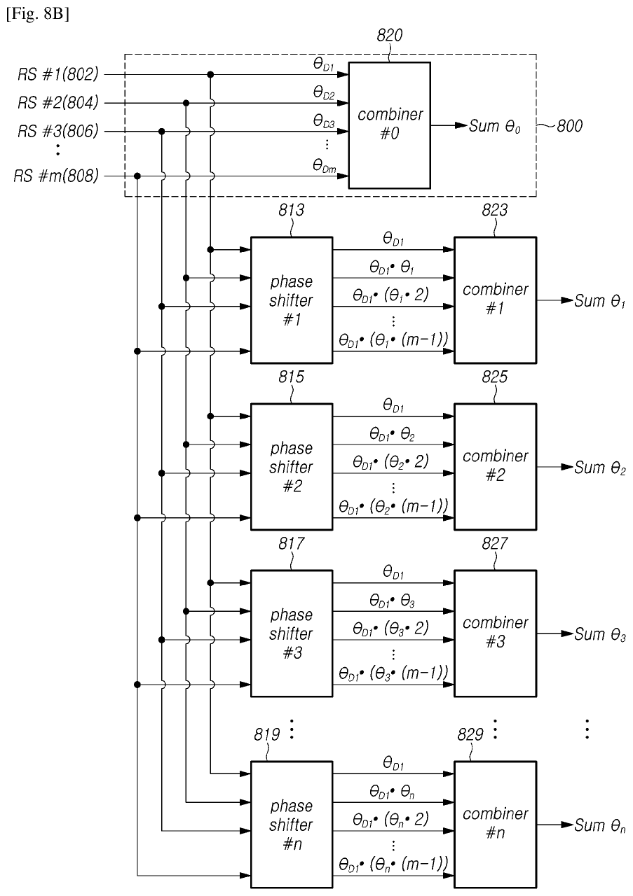

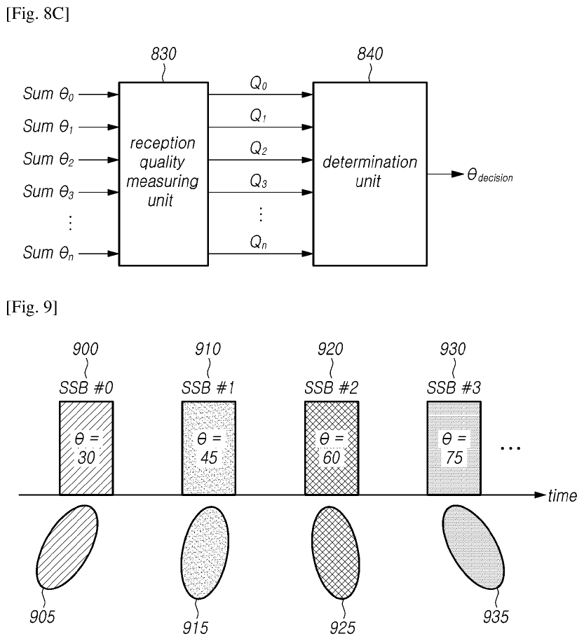

FIG. 8A is a view illustrating an example UE structure for combining reference signals per phase shift value in a wireless communication system according to an embodiment.

Referring to FIG. 8A, the UE 304 may receive M reference signals (or reference signals transmitted M times from the base station 302) and store the M reference signals in the buffer. For example, the UE 304 may receive RS #1 802, RS #2 804, RS #3 806, . . . , RS #m 808 (where m is a natural number equal to or greater than 4) and store them in the buffer. According to an example, M may have a range of ‘2≤M or m≤R (where, R indicates the maximum number of reference signals that the base station 302 may transmit).’

According to an example, RS #1 802, RS #2 804, RS #3 806, . . . , and RS #m 808 stored in the buffer may have phase values of
θ_{D1}, θ_{D2}, θ_{D3}, . . . , θ_{Dm},
   respectively.
θ_{D1}, θ_{D2}, θ_{D3}, . . . , θ_{Dm}
   may be identified by the UE 304 and may be the same as or different from each other.
θ_{D1}, θ_{D2}, θ_{D3}, . . . , θ_{Dm}
   may be the same as or different from phase values used (or set) by the base station 302 for one or more antenna elements when transmitting the reference signal.
θ_{D1}, θ_{D2}, θ_{D3}, . . . , θ_{Dm}
   may be the same as or different from the phase values used by the base station 302 based on the location of the UE 304 or environmental factors (e.g., the presence of a communication obstacle, or the occurrence of signal reflection or refraction).

When RS #1 802, RS #2 804, RS #3 806, . . . , RS #m 808 having phase values of
θ_{D1}, θ_{D2}, θ_{D3}, . . . , θ_{Dm}
   are input, the phase controller 810 may determine whether
θ_{D1}, θ_{D2}, θ_{D3}, . . . , θ_{Dm}
   are the same or different from each other. Although not shown in FIG. 8A, when
θ_{D1}, θ_{D2}, θ_{D3}, . . . , θ_{Dm}
   are the same, the phase controller 810 may output RS #1 802, RS #2 804, RS #3 806, . . . , and RS #m 808 having phase values of
θ_{D1}, θ_{D2}, θ_{D3}, . . . , θ_{Dm}
   as they are.

When
θ_{D1}, θ_{D2}, θ_{D3}, . . . , θ_{Dm}
are different from each other, the phase controller 810 may perform an operation of matching
θ_{D1}, θ_{D2}, θ_{D3}, . . . , θ_{Dm}
to the same phase value.

As an example, the phase controller 810 may determine one of
θ_{D1}, θ_{D2}, θ_{D3}, . . . , θ_{Dm}
   as a reference phase value. For example, the phase controller 810 may determine
θ_{D1}
   as a reference phase value, and perform a phase shift operation for matching each of θ_{D2}, θ_{D3}, . . . , and θ_{Dm}
   to
θ_{D1},
   which is the reference phase value. The phase controller 810 may not perform a phase shift operation on the reference phase value
θ_{D1}.
   The phase controller 810 may output RS #1 802 having the reference phase value
θ_{D1}
   as it is, and output RS #2 804, RS #3 806, . . . , RS #m 808 each of which has been phase-shifted to the reference phase value
θ_{D1}.

According to an example, the phase controller 810 may preset a reference phase value. For example, the phase controller 810 may preset
θ_{R1}
   as a reference phase value, and perform a phase shift operation for matching each of
θ_{D1}, θ_{D2}, θ_{D3}, . . . , θ_{Dm}
   to
θ_{R1},
   which is the preset reference phase value. The phase controller 810 may output RS #1 802, RS #2 804, RS #3 806, . . . , RS #m 808, each of which has been phase-shifted to have the preset reference phase value
θ_{R1}.

In the following description, it is assumed that RS #1 802, RS #2 804, RS #3 806, . . . , RS #m 808 output from the phase controller 810 have the reference phase value
θ_{D1},
but the same may be applied to an example in which they are phase-shifted to have a preset reference phase value
θ_{R1}.
However, when RS #1 802, RS #2 804, RS #3 806, . . . , RS #m 808 output from the phase controller 810 have a phase value of
θ_{R1},
each of the n phase shifters 812, 814, 816, and 818 may output reference signals to which
θ_{R1}
rather than
θ_{D1}
is applied as a reference phase value. Here, n denotes the number of phase shift values or the number of phase shift operations, and may be 1 or more and equal to or less than the total number of phase shift values or the maximum number N of phase shift operations (i.e., 1≤n≤N, where N is a natural number). FIG. 8A illustrates an example in which n has a value equal to or greater than 4.

RS #1 802, RS #2 804, RS #3 806, . . . , RS #m 808 output from the phase controller 810 may be input to n phase shifters, i.e., phase shifter #1 812, phase shifter #2 814, phase shifter #3 816, . . . , and phase shifter #n 818. The phase shifter #1 812, the phase shifter #2 814, the phase shifter #3 816, . . . , and the phase shifter #n 818 may perform phase shift on RS #1 802, RS #2 804, RS #3 806, . . . , and RS #m 808 each having a phase value of
θ_{Dm},
   based on an associated phase shift value among n phase shift values (e.g.,
θ₁, θ₂, θ₃ . . . , θₙ).
   For example, the associated phase shift value of the phase shifter #1 812 may be
θ₁,
   the associated phase shift value of the phase shifter #2 814 may be
θ₂,
   the associated phase shift value of the phase shifter #3 816 may be
θ₃,
   and the associated phase shift value of the phase shifter #n 818 may be
θₙ.

The phase shifter #1 812, the phase shifter #2 814, the phase shifter #3 816, . . . , and the phase shifter #n 818 may perform phase shift based on the phase value
θ_{D1}
of RS #1 802. Accordingly, each of the phase shifter #1 812, the phase shifter #2 814, the phase shifter #3 816, . . . , and the phase shifter #n 818 may not perform phase shift on RS #1 802.

The phase shifter #1 812, the phase shifter #2 814, the phase shifter #3 816, . . . , and the phase shifter #n 818 may determine phase shift values to be applied to RS #2 804, RS #3 806, . . . , and RS #m 808, respectively, based on their respective associated phase shift values and perform phase shifts on RS #2 804, RS #3 806, . . . , and RS #m 808 using the determined respective phase shift values.

According to an example, the phase shifter #1 812 may perform phase shift such that the phase difference between adjacent reference signals becomes
θ₁
   based on the phase value
θ_{D1}
   of RS #1 802. The phase shifter #1 812 may perform a phase shift of
θ_{D1}
   on RS #2 804. The phase shifter #1 812 may perform a phase shift of
“θ_{D1}*(1*2)”
   on RS #3 806. The phase shifter #1 812 may perform a phase shift of
“θ_{D1}*(θ₁*(m−1))”
   on RS #m 808.

According to an example, the phase shifter #1 812 may output RS #1 802 having a phase value of “
θ_{D1}”,
   RS #2 804 having a phase value of
“θ_{D1}*θ₁”,
   RS #3 806 having a phase value of
“θ_{D1}*(θ₁*2)”,
   and RS #m 808 having a phase value of
“θ_{D1}*(θ₁*(m−1))”.

According to an example, the phase shifter #2 814 may perform phase shift such that the phase difference between adjacent reference signals becomes
θ₂
   based on the phase value
θ_{D1}
   of RS #1 802. The phase shifter #2 814 may perform a phase shift of
“θ_{D1}*θ₂”
on RS #2 804. The phase shifter #2 814 may perform a phase shift of
“θ_{D1}*(θ₂*2)”
on RS #3 806. The phase shifter #2 814 may perform a phase shift of
“θ_{D1}*(θ₂*(m−1))”
on RS #m 808.

According to an example, the phase shifter #2 814 may output RS #1 802 having a phase value of “
θ_{D1}”,
   RS #2 804 having a phase value of
“θ_{D1}*θ₂”,
   RS #3 806 having a phase value of
“θ_{D1}*(θ₂*2)”,
   and RS #m 808 having a phase value of
“θ_{D1}*(θ₂*(m−1))”.

According to an embodiment, the phase shifter #3 816 may perform phase shift such that the phase difference between adjacent reference signals becomes
θ₃
   based on the phase value
θ_{D1}
   of RS #1 802. The phase shifter #3 816 may perform a phase shift of
“θ_{D1}*θ₃”
   on RS #2 804. The phase shifter #3 816 may perform a phase shift of
“θ_{D1}*(θ₃*2)”
   on RS #3 806. The phase shifter #3 816 may perform a phase shift of
“θ_{D1}*(θ₃*(m−1))”
   on RS #m 808.

According to an example, the phase shifter #3 816 may output RS #1 802 having a phase value of “
θ_{D1}”,
   RS #2 804 having a phase value of
“θ_{D1}*θ₃”,
   RS #3 806 having a phase value of
“θ_{D1}*(θ₃*2)”,
   and RS #m 808 having a phase value of
“θ_{D1}*(θ₃*(m−1))”.

According to an example, the phase shifter #n 818 may perform phase shift such that the phase difference between adjacent reference signals becomes
θₙ
   based on the phase value
θ_{D1}
   of RS #1 802. The phase shifter #n 818 may perform a phase shift of
“θ_{D1}*θₙ”
   on RS #2 804. The phase shift portion #n 818 may perform a phase shift of
“θ_{D1}*(θₙ*2)”
   on RS #3 806. The phase shifter #n 818 may perform a phase shift of
“θ_{D1}*(θₙ*(m−1))”
   on RS #m 808.

According to an embodiment, the phase shifter #n 818 may output RS #1 802 having a phase value of “
θ_{D1}”,
   RS #2 804 having a phase value of
“θ_{D1}*θₙ”,
   RS #3 806 having a phase value of
“θ_{D1}*(θₙ*2)”,
   and RS #m 808 having a phase value of
“θ_{D1}*(n*(m−1))”.

According to an embodiment, RS #1 802, RS #2 804, RS #3 806, . . . RS #m 808 output from the phase shifter #1 812 may be input to the combiner #1 822. The combiner #1 822 may combine reference signals phase-shifted by the phase-shifter #1 812. The signal combined by the combiner #1 822 may be indicated by Sum
θ₁.

According to an example, RS #1 802, RS #2 804, RS #3 806, . . . RS #m 808 output from phase shifter #2 814 may be input to the combiner #2 824. The combiner #2 824 may combine reference signals phase-shifted by the phase-shifter #2 814. The signal combined by the combiner #2 824 may be indicated by Sum
θ₂.

According to an example, RS #1 802, RS #2 804, RS #3 806, . . . RS #m 808 output from phase shifter #3 816 may be input to the combiner #3 826. The combiner #3 826 may combine reference signals phase-shifted by the phase-shifter #3 816. The signal combined by the combiner #3 826 may be indicated by Sum θ₃.

According to an embodiment, RS #1 802, RS #2 804, RS #3 806, . . . RS #m 808 output from the phase shifter #n 818 may be input to the combiner #n 828. The combiner #n 828 may combine reference signals phase-shifted by the phase-shifter #n 818. The signal combined by the combiner #n 828 may be indicated by Sum
θₙ.

According to an example, the combined signals indicated by Sum
θ₁,
   Sum
θ₂,
   Sum θ₃, . . . ,
   and Sum
θₙ
   may be used to identify an optimal phase shift value. This is described below with reference to FIG. 8C.

According to an example, the UE 304 may not include the phase controller 810. In this case, the operation of the phase controller 810 may be performed by each of the phase shifter #1 812, the phase shifter #2 814, the phase shifter #3 816, . . . , and the phase shifter #n 818. The structure of the UE 304 without the phase controller 810 may be as shown in FIG. 8B as an example.

FIG. 8B is a view illustrating another example UE structure for combining reference signals per phase shift value in a wireless communication system according to an embodiment.

Referring to FIG. 8B, the UE 304 may receive M reference signals (or reference signals transmitted M times from the base station 302) (e.g., RS #1 802, RS #2 804, RS #3 806, . . . , RS #m 808, where m is a natural number greater than or equal to 4) and store them in a buffer.

According to an example, the UE 304 may combine M reference signals without a phase shift. For example, for RS #1 802, RS #2 804, RS #3 806, . . . , RS #m 808 stored in the buffer, the combiner #0 820 may combine RS #1 802, RS #2 804, RS #3 806, . . . , RS #m 808 without phase shift (or without any other processing operation). RS #1 802, RS #2 804, RS #3 806, . . . , and RS #m 808 which are not phase-shifted may have phase values of
θ_{D1}, θ_{D2}, θ_{D3}, . . . , θ_{Dm},
respectively.
θ_{D1}, θ_{D2}, θ_{D3}, . . . , θ_{Dm}
may be identified by the UE 304 and may be the same as or different from each other.
θ_{D1}, θ_{D2}, θ_{D3}, . . . , θ_{Dm}
may be the same as or different from phase values used (or set) by the base station 302 for one or more antenna elements when transmitting the reference signal.
θ_{D1}, θ_{D2}, θ_{D3}, . . . , θ_{Dm}
may be the same as or different from the phase values used by the base station based on the location of the UE 304 or environmental factors (e.g., the presence of a communication obstacle, or the occurrence of signal reflection or refraction). The signal combined by the combiner #0 820 may be indicated by Sum
θ₀.
The combined signals indicated by Sum
θ₀
may be used to identify an optimal phase shift value.

According to an example, the operation 800 of the combiner #0 820 to obtain Sum
θ₀,
   i.e., the operation of combining RS #1 802, RS #2 804, RS #3 806, . . . , RS #m 808 without performing phase shift, may be optionally performed. The combiner #0 820 may or may not be included in the UE 304. Even if the combiner #0 820 is included in the UE 304, it may or may not be used. Therefore, Sum
θ₀
   may be optionally obtained and may or may not be used to identify an optimal phase shift value.

According to an example, the UE 304 may include a phase shifter #1 813, a phase shifter #2 815, a phase shifter #3 817, . . . , and a phase shifter #n 819 for a phase shift operation. The phase shifter #1 813, the phase shifter #2 815, the phase shifter #3 817, . . . , and the phase shifter #n 819 each may perform a first phase shift operation and a second phase shift operation. For example, the first phase shift operation may correspond to an operation performed by the phase controller 810 of FIG. 8A, and the second phase shift operation may correspond to an operation performed by each of the phase shifter #1 812, the phase shifter #2 814, the phase shifter #3 816, . . . , and the phase shifter #n 818 of FIG. 8A.

According to an example, when RS #1 802, RS #2 804, RS #3 806, . . . , and RS #m 808 having phase values of
θ_{D1}, θ_{D2}, θ_{D3}, . . . , θ_{Dm}
   are input, the phase shifter #1 813, the phase shifter #2 815, the phase shifter #3 817, . . . , and the phase shifter #n 819 may determine whether
θ_{D1}, θ_{D2}, θ_{D3}, . . . , θ_{Dm}
   are the same or different from each other.

When it is determined that
θ_{D1}, θ_{D2}, θ_{D3}, . . . , θ_{Dm}
   are the same as each other, the phase shifter #1 813, the phase shifter #2 815, the phase shifter #3 817, . . . , and the phase shifter #n 819 may not perform the first phase shift operation of matching
θ_{D1}, θ_{D2}, θ_{D3}, . . . , θ_{Dm}
   to the same phase value. Accordingly, the phase shifter #1 813, the phase shifter #2 815, the phase shifter #3 817, . . . , and the phase shifter #n 819 may use RS #1 802, RS #2 804, RS #3 806, . . . , and RS #m 808 having phase values of
θ_{D1}, θ_{D2}, θ_{D3}, . . . , and θ_{Dm},
   respectively, for the second phase shift operation.

When it is determined that
θ_{D1}, θ_{D2}, θ_{D3}, . . . , θ_{Dm}
   are different from each other, the phase shifter #1 813, the phase shifter #2 815, the phase shifter #3 817, . . . , and the phase shifter #n 819 may perform the first phase shift operation of matching
θ_{D1}, θ_{D2}, θ_{D3}, . . . , θ_{Dm}
   to the same phase value. The first phase shift operation may be a phase shift operation for determining one of
θ_{D1}, θ_{D2}, θ_{D3}, . . . , θ_{Dm},
   e.g.,
θ_{D1}
   as a reference phase value and matching
θ_{D2}, θ_{D3}, . . . , θ_{Dm}
   to
θ_{D1},
   which is a reference phase value. The first phase shift operation may not be performed on the reference phase value
θ_{D1}.
   RS #1 802 having the reference phase value
θ_{D1}
   may be used for the second phase shift operation as it is, and RS #2 804, RS #3 806, . . . , RS #m 808 may be used for the second phase shift operation after their phase values are changed to
θ_{D1}.

Since the second phase shift operation performed by each of the phase shifter #1 813, the phase shifter #2 815, the phase shifter #3 817, . . . , and the phase shifter #n 819 corresponds to the operation performed by each of the phase shifter #1 812, the phase shifter #2 814, the phase shifter #3 816, . . . , and the phase shifter #n 818 of FIG. 8A, a detailed description of the second phase shift operation will be omitted.

Since the combiner #1 823, the combiner #2 825, the combiner #3 827, . . . , and the combiner #n 829 respectively correspond to the combiner #1 822, the combiner #2 824, the combiner #3 826, . . . , and the combiner #n 828 of FIG. 8A, a detailed description of each of the combiner #1 823, the combiner #2 825, the combiner #3 827, . . . , and the combiner #n 829 will be omitted.

In the example illustrated in FIGS. 8A and 8B, it has been described that there are a plurality of phase shifters and a plurality of combiners. However, at least one of the phase shifter or the combiner may be configured as a single component. For example, one phase shifter may perform phase shift on M reference signals based on each of n phase shift values (e.g.,
θ₁, θ₂, θ₃ . . . , θₙ).
   For example, one combiner may combine phase-shifted signals for each of n phase shift values for each phase shift value.

FIG. 8C is a view illustrating an example UE structure for identifying an optimal phase shift value in a wireless communication system according to an embodiment.

Referring to FIG. 8C, the UE 304 may include a reception quality measuring unit 830 and a determination unit 840 to identify an optimal phase shift value.

The reception quality measuring unit 830 may measure the reception quality for each of the combined signals indicated by Sum
θ₀,
   Sum
θ₁,
   Sum
θ₂,
Sum
θ₃, . . . ,
and Sum
θₙ.
For example, reception quality Q₀ may be measured corresponding to Sum
θ₀,
reception quality Q₁ may be measured corresponding to Sum
θ₁,
reception quality Q₂ may be measured corresponding to Sum
θ₂,
reception quality Q₃ may be measured corresponding to Sum
θ₃,
and reception quality Qₙ may be measured corresponding to Sum
θₙ.
As described with reference to FIG. 8B, since Sum
θ₀
may be optionally obtained, the combined signal indicated by Sum
θ₀
may not be used by the reception quality measuring unit 830, and the reception quality Q₀ corresponding to Sum
θ₀
may not be measured.

The determination unit 840 may identify a reception quality (e.g., a reception quality greater than or equal to a threshold or the best reception quality) meeting a set criterion among the measured reception qualities Q₀, Q₁, Q₂, Q₃, . . . , and Qₙ, and identify a phase shift value corresponding to the identified reception quality as an optimal phase shift value
θ_{decision}.

The UE 304 may report the optimal phase shift value
θ_{decision}
   to the base station 302. As additional information, the UE 304 may report, to the base station 302, at least one of information about the reference signals combined based on the optimal phase shift value, i.e., optimal combination reference signals (e.g., information about the number of optimal combination reference signals or resource index information about each of the optimal combination reference signals) or information about the reception quality of the optimal combination reference signals. The optimal phase shift value
θ_{decision}
may be an estimated value for a phase difference occurring between antenna elements of the base station 302. Accordingly, the base station 302 may use the optimal phase shift value
θ_{decision}
to perform beamforming for the UE 304. For example, when the optimal phase shift value
θ_{decision}
is 45°, the base station 302 may perform beamforming for the UE 304 by applying a phase shift value of 45° between the antenna elements. The antenna elements to which the phase shift value of 45° is applied may be antenna elements respectively related to the optimal combination reference signals identified based on the additional information.

According to an example, when the UE 304 has a plurality of reception antennas, the operations illustrated in FIGS. 8A to 8C may be performed independently for each reception antenna, or may be performed only on reference signals received through some reception antennas. Or, the UE 304 may generate a combination of receiving ends for reference signals received through other reception antennas and the same radio resource and then perform the operations disclosed in FIGS. 8A to 8C on reference signals corresponding to the receiving end combination.

FIG. 9 is a view illustrating example SSBs used to obtain a plurality of phase shift values in a wireless communication system according to an embodiment.

Referring to FIG. 9, the base station 302 may transmit a plurality of SSBs. For example, the base station 302 may transmit SSB #0 900, SSB #1 910, SSB #2 920, and SSB #3 930 through beam sweeping. For example, SSB #0 900 may be transmitted through beam #0 905 of the base station 302. For example, SSB #1 910 may be transmitted through beam #1 915 of the base station 302. For example, SSB #2 920 may be transmitted through beam #2 925 of the base station 302. For example, SSB #3 930 may be transmitted through beam #4 935 of the base station 302. SSB #0 900, SSB #1 910, SSB #2 920, and SSB #3 930 may be transmitted using different time resources.

The UE 304 may obtain synchronization with the base station 302 using SSB #1 910 among the plurality of SSBs. Based on this, the UE 304 may obtain a phase value corresponding to SSB #1 910 from the SIB. According to an example, the SIB may include phase values respectively corresponding to SSB #0 900, SSB #1 910, SSB #2 920, and SSB #3 930. The SIB may indicate, e.g., that the phase value
θ
corresponding to SSB #0 900 is 30°. The SIB may indicate, e.g., that the phase value
θ
corresponding to SSB #1 910 is 45°. The SIB may indicate, e.g., that the phase value
θ
corresponding to SSB #2 920 is 60°. The SIB may indicate, e.g., that the phase value
θ
corresponding to SSB #3 930 is 75°.

According to an example, the UE 304 may obtain the phase value
θ
   corresponding to SSB #1 910 from the SIB as 45°, and may use the phase shift values, e.g., {35°, 40°, 45°, 50°, 55° } with the obtained 450 as the center value to perform the phase-shifted combining operation for beam search.

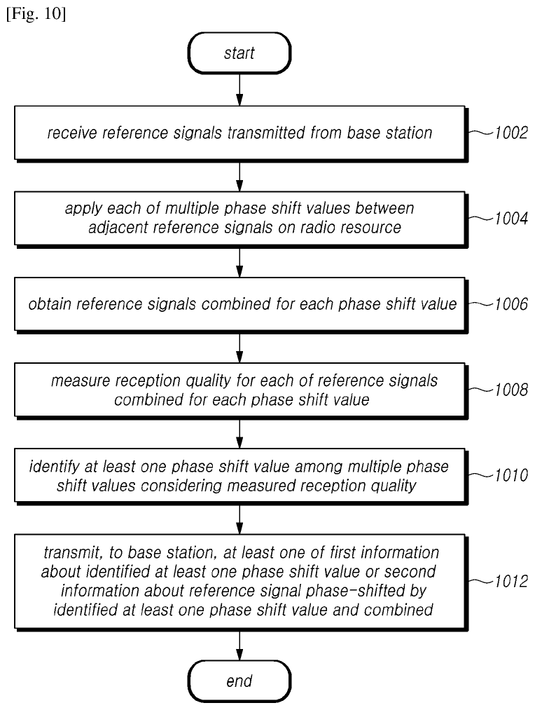

FIG. 10 is a flowchart illustrating an example of performing a beam control procedure by a UE in a wireless communication system according to an embodiment.

Referring to FIG. 10, in operation 1002, the UE 304 may receive reference signals transmitted from the base station 302. The reference signals transmitted from the base station 302 may include, e.g., one of a reference signal transmitted M times from one or more antenna elements of the base station 302 or M reference signals transmitted from a plurality of antenna elements of the base station 302. The reference signal transmitted M times or the M reference signals may be reference signals transmitted using different radio resources. The UE 304 may receive reference signals transmitted from the base station 302 based on direction information obtained after initial beam configuration with the base station 302.

The UE 304 may receive reference signal configuration information from the base station 302 and may receive reference signals transmitted from the base station 302 based on the received reference signal configuration information. The reference signal configuration information may include at least one of radio resource information related to the reference signals, transmission count information related to the reference signals, radio resource count information related to the reference signals, sequence information related to the reference signals, or transmission power information related to the reference signals.

In operation 1004, the UE 304 may apply each of the plurality of phase shift values between adjacent reference signals on the reference signal, targeting the reference signals transmitted from the base station 302. The adjacent reference signals on the radio resource may be adjacent reference signals in the time and/or frequency domain, or reference signals transmitted using adjacent radio resources in the time and/or frequency domain. As an example, the operation of applying each of the plurality of phase shift values between adjacent reference signals on the radio resource may be the operation performed by the n phase shifters 812, 814, 816, and 818 or 813, 815, 817, and 819 as illustrated in FIG. 8A or 8B.

According to an example, the plurality of phase shift values may be provided from the base station 302 or may be determined based on the reference phase shift value provided by the base station 302. The plurality of phase shift values may be obtained considering, e.g., the degree of phase shift predicted corresponding to each beam when the base station 302 performs beam sweeping according to beamforming. The reference phase shift value may be obtained from, e.g., the phase value of the SSB received by the UE 304 for synchronization with the base station 302, or TCI state configuration information related to at least one of reference signals transmitted from the base station 302.

In operation 1006, the UE 304 may combine reference signals having the same applied phase shift value to obtain the combined reference signals for each phase shift value. As an example, the operation of obtaining the combined reference signals for each phase shift value may be an operation as shown in Equation 1, or an operation performed by the n combiners 822, 824, 826, and 828 or 823, 825, 827, and 829 as shown in FIG. 8A or 8B.

In operation 1008, the UE 304 may measure the reception quality of each of the reference signals combined for each phase shift value. As an example, the operation of measuring the reception quality of each of the reference signals combined for each phase shift value may be an operation performed by the reception quality measuring unit 830 of FIG. 8C.

In operation 1010, the UE 304 may identify at least one phase shift value among the plurality of phase shift values considering the measured reception quality. For example, the UE 304 may identify at least one phase shift value among the plurality of phase shift values based on the reception quality meeting the set criterion among the reception qualities measured for each phase shift value. As an example, the operation of identifying at least one phase shift value may be an operation performed by the determination unit 840 of FIG. 8C.

In operation 1012, the UE 304 may transmit, to the base station 302, at least one of first information indicating the identified at least one phase shift value or second information regarding reference signals phase-shifted by the identified at least one phase shift value and combined. For example, the first information may be used to apply the identified at least one phase shift value between antenna elements of the base station 302 for beamforming of the base station 302. For example, the second information may be used to determine antenna elements for beamforming of the base station 302 among the antenna elements of the base station 302.

According to an example, the second information may include at least one of resource index information corresponding to the reference signals phase-shifted by the identified at least one phase shift value and combined or information about the number of the reference signals phase-shifted by the identified at least one phase shift value and combined.

According to an example, when the identified at least one phase shift value includes a plurality of phase shift values, and the first information is transmitted to the base station 302, the UE 304 may receive, from the base station 302, third information indicating the first phase shift value among the plurality of phase shift values. The UE 304 may identify that the base station 302 performs beamforming based on the first phase shift value, based on the third information.

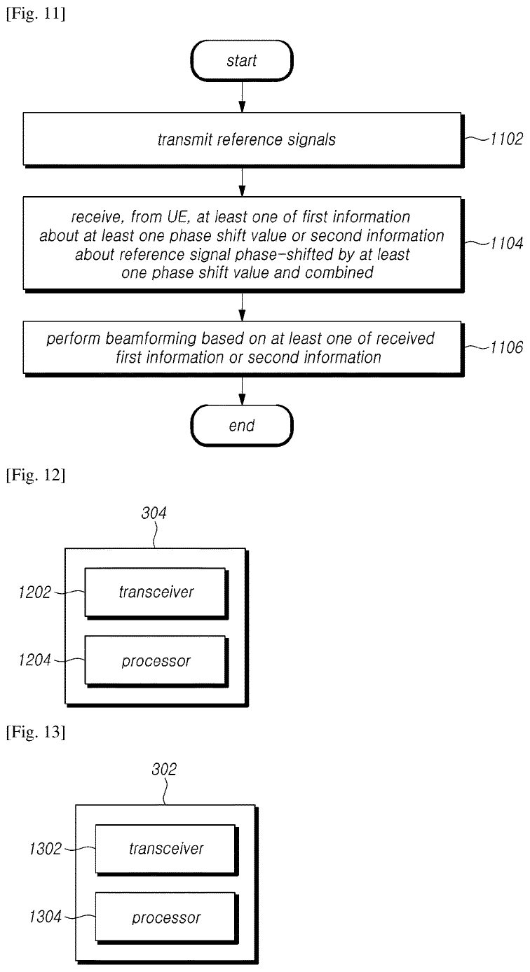

FIG. 11 is a flowchart illustrating an example of performing a beam control procedure by a base station in a wireless communication system according to an embodiment.

Referring to FIG. 11, in operation 1102, the base station 302 may transmit reference signals to the UE 304. For example, the base station 302 may transmit a reference signal M times through one or more antenna elements, or may transmit M reference signals through a plurality of antenna elements. The reference signal transmitted M times or M reference signals may correspond to different radio resources.

According to an example, the base station 302 may transmit the reference signal configuration information to the UE 304 before transmitting the reference signals. The reference signal configuration information may include at least one of radio resource information related to the reference signals, transmission count information related to the reference signals, radio resource count information related to the reference signals, sequence information related to the reference signals, or transmission power information related to the reference signals.

In operation 1104, the base station 302 may receive, from the UE 304, at least one of first information indicating at least one phase shift value among the plurality of phase shift values or second information regarding reference signals phase-shifted by the identified at least one phase shift value and combined. According to an example, the plurality of phase shift values may be provided by the base station 302 to the UE 304. According to an example, the plurality of phase shift values may be determined by the UE 304 based on the reference phase shift value provided by the base station 302. The reference phase shift value may be provided to the UE 304 through, e.g., system information indicating the phase value of the SSB received by the UE 304 for synchronization with the base station 302, or TCT state configuration information related to at least one of reference signals.

In operation 1106, the base station 302 may perform beamforming for the UE 304 based on at least one of the received first information or second information. For example, when the base station 302 receives the first information, the base station 302 may apply at least one phase shift value between antenna elements for beamforming based on the first information. For example, when the base station 302 receives the second information, the base station 302 may determine antenna elements for beamforming based on the second information. According to an example, before performing beamforming, the base station 302 may transmit information about at least one phase shift value, as information about the final beam for communication with the UE 304, to the UE 304. The information about the at least one phase shift value may include information indicating at least one phase shift value, or an indicator or index indicating at least one phase shift value.

According to an example, when the base station 302 receives the first information from the UE 304, the base station 302 may transmit response information (e.g., acknowledgement (ACK) information) indicating that at least one phase shift value indicated by the received first information is to be used, to the UE 304.

According to an example, when the base station 302 receives the first information from the UE 304 and the at least one phase shift value indicated by the first information includes a plurality of phase shift values, the base station 302 may transmit third information indicating the first phase shift value among the plurality of phase shift values to the UE 304. The first phase shift value may be used to be applied between antenna elements to perform beamforming by the base station 302. The first phase shift value may be selected by the base station 302 as a phase shift value corresponding to the best reception quality among the plurality of phase shift values.

FIG. 12 is a block diagram illustrating a configuration of a UE in a wireless communication system according to an embodiment.

Referring to FIG. 12, the UE 304 may include a transceiver 1202 and a processor 1204.

The transceiver 1202 may communicate with the base station 302 or other network entities. The transceiver 1202 may support various technologies for wireless communication. As an example, the transceiver 1202 may support a 5G network, after the 4G network, and next-generation communication technology, e.g., new radio (NR) access technology.

The processor 1204 may be operably connected to the transceiver 1202 to control the overall operation of the transceiver 1202. According to an example, the processor 1204 may perform the above-described operations of the UE 304. For example, the processor 1204 may perform the following operations.

The processor 1204 may receive reference signals transmitted from the base station 302 through the transceiver 1202. The reference signals transmitted from the base station 302 may include, e.g., one of a reference signal transmitted M times from one or more antenna elements of the base station 302 or M reference signals transmitted from a plurality of antenna elements of the base station 302. The reference signal transmitted M times or the M reference signals may be reference signals transmitted using different radio resources. The processor 1204 may receive reference signals transmitted from the base station 302 based on direction information obtained after initial beam configuration with the base station 302.

The processor 1204 may receive reference signal configuration information from the base station 302 through the transceiver 1202 and may receive reference signals based on the received reference signal configuration information. The received reference signal configuration information may include at least one of radio resource information related to the reference signals, transmission count information related to the reference signals, radio resource count information related to the reference signals, sequence information related to the reference signals, or transmission power information related to the reference signals.

The processor 1204 may apply each of the plurality of phase shift values between adjacent reference signals on the reference signal, targeting the reference signals transmitted from the base station 302. The adjacent reference signals on the radio resource may be adjacent reference signals in the time and/or frequency domain, or reference signals transmitted using adjacent radio resources in the time and/or frequency domain.

According to an example, the plurality of phase shift values may be provided from the base station 302 or may be determined based on the reference phase shift value provided by the base station 302. The plurality of phase shift values may be obtained considering, e.g., the degree of phase shift predicted corresponding to each beam when the base station 302 performs beam sweeping according to beamforming. The reference phase shift value may be obtained from, e.g., the phase value of the SSB received for synchronization with the base station 302, or TCI state configuration information related to at least one of reference signals transmitted from the base station 302.

The processor 1204 may combine reference signals having the same applied phase shift value to obtain the combined reference signals for each phase shift value. The processor 1204 may measure the reception quality of each of the reference signals combined for each phase shift value. The processor 1204 may identify at least one phase shift value among the plurality of phase shift values considering the measured reception quality. For example, the processor 1204 may identify at least one phase shift value among the plurality of phase shift values based on the reception quality meeting the set criterion among the reception qualities measured for each phase shift value.

The processor 1204 may control the transceiver 1202 to transmit, to the base station 302, at least one of first information indicating the identified at least one phase shift value or second information regarding reference signals phase-shifted by the identified at least one phase shift value and combined. For example, the first information may be used to apply the identified at least one phase shift value between antenna elements of the base station 302 for beamforming of the base station 302. For example, the second information may be used to determine antenna elements for beamforming of the base station 302 among the antenna elements of the base station 302.

According to an example, the second information may include at least one of resource index information corresponding to the reference signals phase-shifted by the identified at least one phase shift value and combined or information about the number of the reference signals phase-shifted by the identified at least one phase shift value and combined.

According to an example, when the identified at least one phase shift value includes a plurality of phase shift values, and the first information is transmitted to the base station 302, the processor 1204 may receive, from the base station 302 through the transceiver 1202, third information indicating the first phase shift value among the plurality of phase shift values. The processor 1204 may identify that the base station 302 performs beamforming based on the first phase shift value, based on the third information.

FIG. 13 is a block diagram illustrating a configuration of a base station in a wireless communication system according to an embodiment.

Referring to FIG. 13, the base station 302 may include a transceiver 1302 and a processor 1304.

The transceiver 1302 may communicate with the UE 304 or other network entities. The transceiver 1302 may support various technologies for wireless communication. As an example, the transceiver 1302 may support a 5G network, after the 4G network, and next-generation communication technology, e.g., NR access technology. According to an example, the transceiver 1302 may include a transmission unit as illustrated in FIG. 1.

The processor 1304 may be operably connected to the transceiver 1302 to control the overall operation of the transceiver 1302. According to an example, the processor 1304 may perform the above-described operations of the base station 302. For example, the processor 1304 may perform the following operations.

The processor 1304 may control the transceiver 1302 to transmit the reference signals to the UE 304. For example, the processor 1304 may transmit a reference signal M times through one or more antenna elements, or may transmit M reference signals through a plurality of antenna elements. The reference signal transmitted M times or M reference signals may correspond to different radio resources.

According to an example, the processor 1304 may control the transceiver 1302 to transmit the reference signal configuration information to the UE 304 before transmitting the reference signals. The reference signal configuration information may include at least one of radio resource information related to the reference signals, transmission count information related to the reference signals, radio resource count information related to the reference signals, sequence information related to the reference signals, or transmission power information related to the reference signals.

The processor 1304 may receive, from the UE 304 through the transceiver 1302, at least one of first information indicating at least one phase shift value among the plurality of phase shift values or second information regarding reference signals phase-shifted by the identified at least one phase shift value and combined. According to an example, the plurality of phase shift values may be provided to the UE 304 by the processor 1304. According to an example, the plurality of phase shift values may be determined by the UE 304 based on the reference phase shift value provided by the processor 1304. The reference phase shift value may be provided to the UE 304 through, e.g., system information indicating the phase shift value of the SSB received by the UE 304 for synchronization with the base station 302, or TCI state configuration information related to at least one of reference signals.

The processor 1304 may perform beamforming for the UE 304 based on at least one of the received first information or second information. For example, when receiving the first information, the processor 1304 may apply at least one phase shift value between antenna elements for beamforming based on the first information. For example, when the base station 302 receives the second information, the base station 302 may determine antenna elements for beamforming based on the second information.

According to an example, before performing beamforming, the processor 1304 may control the transceiver 1302 to transmit information about at least one phase shift value, as information about the final beam, to the UE 304. The information about the at least one phase shift value may include information indicating at least one phase shift value, or an indicator or index indicating at least one phase shift value. According to an example, when the processor 1304 receives the first information from the UE 304, the processor 1304 may control the transceiver 1302 to transmit response information (e.g., ACK information) indicating that at least one phase shift value indicated by the received first information is to be used to the UE 304.

According to an example, when the processor 1304 receives the first information from the UE 304 and the at least one phase shift value indicated by the first information includes a plurality of phase shift values, the processor 1304 may control the transceiver 1302 to transmit third information indicating the first phase shift value among the plurality of phase shift values to the UE 304. The processor 1304 may use the first phase shift value to be applied between the antenna elements to perform beamforming. The first phase shift value may be selected by the processor 1304 as a phase shift value corresponding to the best reception quality among the plurality of phase shift values.

It should be noted that the configuration views, signal flowcharts, flowcharts, operational procedure views of FIGS. 1 to 13 are not intended as limiting the scope of the embodiments of the disclosure. In other words, all the components, entities, or operations illustrated in FIGS. 1 to 13 should not be construed as essential components to practice the disclosure, and the disclosure may be rather implemented with only some of the components without departing from the gist of the embodiments of the disclosure.

The operations of the above-described embodiments may be implemented by providing a memory device storing a corresponding program code in any component of the device. In other words, the processors in the base station 302 and the UE 304 may execute the above-described operations by reading and executing the program codes stored in the memory device by a controller or a central processing unit (CPU).

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

1. A method for supporting beamforming by a user equipment (UE) in a wireless communication system, the method comprising:
receiving reference signals from a base station;
performing a first operation of applying a first phase shift value to the received reference signals to allow adjacent reference signals on a radio resource to have a set phase difference;
performing a second operation of obtaining a combined reference signal by combining the first phase shift value-applied reference signals;
performing a third operation of measuring a first reception quality of the combined reference signal;
performing the first, second, and third operations by applying at least one second phase shift value instead of the first phase shift value, the at least one second phase shift value including at least one phase shift value to allow the adjacent reference signals to have a phase difference different from the set phase difference;
obtaining a second reception quality measured for each of the at least one second phase shift value based on the first, second, and third operations performed by applying the at least one second phase shift value;
identifying at least one phase shift value among the first phase shift value and the at least one second phase shift value based on the first reception quality measured for the first phase shift value and the second reception quality measured for each of the at least one second phase shift value; and
transmitting, to the base station, at least one of first information indicating the identified at least one phase shift value or second information regarding reference signals phase-shifted by the identified at least one phase shift value and combined.

2. The method of claim 1, wherein receiving the reference signals from the base station comprises receiving the reference signals transmitted from the base station based on direction information obtained after initial beam setup with the base station, and
wherein the reference signals transmitted from the base station include one of a reference signal transmitted multiple times from one or more antenna elements of the base station or a plurality of reference signals transmitted from a plurality of antenna elements of the base station.

3. The method of claim 1, wherein the first information is used to apply the identified at least one phase shift value between antenna elements of the base station for beamforming by the base station, and
wherein the second information is used to determine antenna elements for beamforming by the base station among a plurality of antenna elements of the base station.

4. The method of claim 1, wherein the second information includes at least one of resource index information corresponding to the reference signals phase-shifted by the identified at least one phase shift value and combined or information about the number of the reference signals phase-shifted by the identified at least one phase shift value and combined.

5. The method of claim 1, wherein the first phase shift value and the at least one second phase shift value are provided from the base station or are determined based on a reference phase shift value provided from the base station.

6. The method of claim 5, wherein the reference phase shift value is obtained from a phase value of a synchronization signal block (SSB) received for synchronizing with the base station or transmission configuration indication (TCI) state configuration information related to at least one of the reference signals transmitted from the base station.

7. The method of claim 1, further comprising:
in response to the identified at least one phase shift value including a plurality of phase shift values, and transmitting the first information to the base station, receiving third information indicating a third phase shift value among the plurality of phase shift values from the base station; and
identifying that the base station performs beamforming based on the third phase shift value based on the third information.

8. The method of claim 1, wherein receiving the reference signals from the base station comprises receiving reference signal configuration information from the base station and receiving the reference signals transmitted from the base station based on the received reference signal configuration information, and
wherein the received reference signal configuration information includes at least one of radio resource information related to the reference signals transmitted from the base station, transmission count information related to the reference signals transmitted from the base station, radio resource count information related to the reference signals transmitted from the base station, sequence information related to the reference signals transmitted from the base station, or transmission power information related to the reference signals transmitted from the base station.

9. A method for supporting beamforming by a base station in a wireless communication system, the method comprising:
transmitting reference signals;
receiving, from a user equipment (UE), at least one of first information indicating at least one phase shift value among a plurality of phase shift values or second information regarding reference signals phase-shifted by the at least one phase shift value and combined, in response to transmitting the reference signals; and
performing beamforming for the UE based on the received at least one information,
wherein the first information is used to identify the at least one phase shift value to be applied between antenna elements of the base station, and the second information is used to determine the antenna elements for beamforming.

10. The method of claim 9, further comprising transmitting reference signal configuration information for the reference signals to the UE,
wherein the reference signal configuration information includes at least one of radio resource information related to the reference signals, transmission count information related to the reference signals, radio resource count information related to the reference signals, sequence information related to the reference signals, or transmission power information related to the reference signals.

11. A user equipment (UE) in a wireless communication system, comprising:
a transceiver; and
at least one processor operably connected to the transceiver, wherein the at least one processor is configured to:
receive reference signals from a base station through the transceiver;
perform a first operation of applying a first phase shift value to the received reference signals to allow adjacent reference signals on a radio resource to have a set phase difference;
perform a second operation of obtaining a combined reference signal by combining the first phase shift value-applied reference signals;
perform a third operation of measuring a first reception quality of the combined reference signal;
perform the first, second, and third operations by applying at least one second phase shift value instead of the first phase shift value, the at least one second phase shift value including at least one phase shift to allow the adjacent reference signals to have a phase difference different from the set phase difference;
obtain a second reception quality measured for each of the at least one second phase shift value based on the first, second, and third operations performed by applying the at least one second phase shift value;
identify at least one phase shift value among the first phase shift value and the at least one second phase shift value based on the first reception quality measured for the first phase shift value and the second reception quality measured for each of the at least one second phase shift value; and
control the transceiver to transmit, to the base station, at least one of first information indicating the identified at least one phase shift value or second information regarding reference signals phase-shifted by the identified at least one phase shift value and combined.

12. The UE of claim 11, wherein the at least one processor is configured to perform operations described in one of claims 2 to 8.

13. A base station in a wireless communication system, the base station comprising:
a transceiver; and
at least one processor operably connected to the transceiver, wherein the at least one processor is configured to:
control the transceiver to transmit reference signals;
receive, from a user equipment (UE) through the transceiver, at least one of first information indicating at least one phase shift value among a plurality of phase shift values or second information regarding reference signals phase-shifted by the at least one phase shift value and combined, in response to transmitting the reference signals; and
perform beamforming for the UE based on the received at least one information, wherein the first information is used to identify the at least one phase shift value to be applied between antenna elements of the base station, and the second information is used to determine the antenna elements for beamforming.

14. The base station of claim 13, wherein the at least one processor is configured to control the transceiver to transmit reference signal configuration information for the reference signals to the UE, and
wherein the reference signal configuration information includes at least one of radio resource information related to the reference signals, transmission count information related to the reference signals, radio resource count information related to the reference signals, sequence information related to the reference signals, or transmission power information related to the reference signals.
